(19) United States
(12) Patent Application Publication
(10) Pub. No.: US 2011/0043603 A1
(43) Pub. Date: Feb. 24, 2011

(54) System And Method For Dehazing

(75) Inventors: Yoav Schechner, Kiryat Bialik (IL); Einav Namer, Kibutz Yagur (IL); Sarit Shwartz, Haifa (IL)

Correspondence Address: William H. Dippert;Eckert Seamans Cherin & Mellott, LLC, U.S. Steel Tower, 600 Grant Street, 44th Floor, Pittsburgh, PA, 15219, US

(73) Assignee: TECHNION RESEARCH & DEVELOPMENT FOUNDATION LTD., Haifa (IL)

(21) Appl. No.: 12/161,198

(22) PCT Filed: Jan. 18, 2007
(86) PCT No.: PCT/IL2007/000067

§ 371 Date: Nov. 15, 2010

Related U.S. Application Data
(60) Provisional application No. 60/759,579, filed on Jan. 18, 2006.

(51) Int. Cl. H04N 5/14; G06K 9/40

(52) U.S. Cl. 348/25; 382/275; 382/264; 348/E05.062

(57) ABSTRACT

Outdoor imaging is plagued by poor visibility conditions due to atmospheric scattering, particularly in haze. A major problem is spatially-varying reduction of contrast by stray radiance (airlight), which is scattered by the haze particles towards the camera. The images can be compensated for haze by subtraction of the airlight and correcting for atmospheric attenuation. Airlight and attenuation parameters are computed by analyzing polarization-filtered images. These parameters were estimated in past studies by measuring pixels in sky areas. However, the sky is often unseen in the field of view. The invention provides methods for automatically estimating these parameters, when the sky is not in view.

### FIELD OF THE INVENTION

The present invention relates to a system and method for estimation and correcting intensity and color distortions of images of three dimensional objects caused by scattering.

### BACKGROUND OF THE INVENTION

Imaging in poor atmospheric conditions affects human activities, as well as remote sensing and surveillance. Hence, analysis of images taken in haze is important.

Moreover, research into atmospheric imaging promotes other domains of vision through scattering media, such as water and tissue. Several computer vision approaches have been proposed to handle scattering environments.

An effective approach for analyzing hazy images based on polarization and capitalizes on the fact that one of the sources of image degradation in haze is partially polarized. Such analysis yields an estimate for the distance map of the scene, in addition to a dehazed image. Example of this approach is given in: [24] E. Namer and Y. Y. Schechner. “Advanced visibility improvement based on polarization filtered images”. In Proc. SPIE 5888, pages 36-45, 2005. and [33] Y. Y. Schechner, S. G. Narasimhan, and S. K. Nayar. “Polarization-based vision through haze”. App. Opt., 42:511-525, 2003.

[48] Yoav Y. Schechner, Srinivasa G. Narasimhan and Shree K. Nayar “Instant Dehazing of Images Using Polarization”. Proc. Computer Vision & Pattern Recognition Vol. 1, pp. 325-332 (2001).

Environmental parameters are required to invert the effects of haze. In particular, it is important to know the parameters of stray light (called airlight) created by haze, which greatly decreases image contrast.

A method for determining these parameters from the image data was shown in:
[25] S. G. Narasimhan and S. K. Nayar. “Vision and the atmosphere”. Int. J. Comp. Vis., 48:233-254, 2002.

The abovementioned method is applicable for cases of fog or heavy haze (achromatic scattering). The method requiring inter-frame weather changes, i.e., long acquisition periods.

Some references by the inventors, which further give background information are:
[36] S. Shwartz, E. Namer, and Y. Y. Schechner. Blind haze separation. Proc. IEEE Computer Soc. Conf. on Computer Vision and Pattern Recognition, volume 2, pages 1984-1991, 2006.
[37] S. Shwartz, M. Zibulevsky, and Y. Y. Schechner. Fast kernel entropy estimation and optimization. Signal Processing, 85:1045-1058, 2005.
[41] T. Treibitz and Y. Y. Schechner. Instant 3Descatter. In Proc. IEEE Computer Soc. Con. on Computer Vision and Pattern Recognition, volume 2, pages 1861-1868, 2006.

### OTHER REFERENCES

[1] E. H. Adelson. Lightness perception and lightness illusions, chapter 23, pages 339-351. MIT, Cambridge, 2 edition, 2000.
[2] G. Atkinson and E. Hancock. Polarization-based surface reconstruction via patch matching. Proc. IEEE Computer Soc. Conf. on Computer Vision and Pattern Recognition, vol. 1, pages 495-502, 2006.
[3] S. J. Bell and T. J. Sejnowski. An information-maximization approach to blind separation and blind deconvolution. Neural Computation, 7:1129-1159, 1995.
[4] P. Bofill and M. Zibulevsky. Underdetermined blind source separation using sparse representations. Signal Processing, 81:2353-2362, 2001.
[5] J.-F. Cardoso. Blind signal separation: statistical principles. Proc. IEEE, 86:2009-2025, 1998.
[6] T. M. Cover and J. A. Thomas. Elements of Information Theory. John Wiley and Sons, New York, 1991.
[7] F. Cozman and E. Kroktov. Depth from scattering. In Proc. IEEE Computer Soc. Conf. on Computer Vision and Pattern Recognition, pages 801-806, 1997.
[8] O. G. Cula, K. J. Dana, D. K. Pai, and D. Wang. Polarization multiplexing for bidirectional imaging. In Proc. IEEE Computer Soc. Conf. on Computer Vision and Pattern Recognition, volume 2, pages 1116-1123, 2005.
[9] S. G. Demos and R. R. Alfano. Optical polarization imaging. App. Opt., 36:150-155, 1997.
[10] F. de la Torre, R. Gross, S. Baker, and B. V. K. Vijaya Kumar. Representational oriented component analysis (ROCA) for face recognition with one sample image per training class. In Proc. Computer Soc. Conf. on Computer Vision and Pattern Recognition, volume 2, pages 266-273, 2005.
[11] O. Drbohlav and R. Śâra. Unambiguous determination of shape from photometric stereo with unknown light sources. Proc. IEEE Int. Conf. on Computer Vision, volume 1, pages 581-586, 2001.
[12]H. Farid and E. H. Adelson. Separating reflections from images by use of independent component analysis. J. Opt. Soc. Amer A, 16:2136-2145, 1999.
[13] K. Garg and S. K. Nayar. Detection and removal of A_{∞} from videos. In Proc. IEEE Computer Soc. Conf. on Computer Vision and Pattern Recognition, volume 1, pages 528-535, 2004.
[14] S. Harsdorf, R. Reuter, and S. Tonebon. Contrast-enhanced optical imaging of submersible targets. In Proc. SPIE, volume 3821, pages 378-383, 1999.
[15] A. Hyv.arinen, J. Karhunen, and E. Oja. Independent Component Analysis. John Wiley and Sons, New York, 2001.
[16] J. S. Jaffe. Computer modelling and the design of optimal underwater imaging systems. IEEE J. Oceanic Eng., 15:101-111, 1990.
[17] P. Kisilev, M. Zibulevsky, and Y. Y. Zeevi. Multiscale framework for blind source separation. J. of Machine Learning Research, 4:1339-63, 2004.
[18] D. M. Kocak and F. M. Caimi. The current art of underwater imaging with a glimpse of the past. MTS Journal, 39:5-26, 2005.
[19] N. S. Kopeika. A System Engineering Approach to Imaging, SPIE Press, Bellingham, Wash., 1998.
[20] T.-W. Lee and M. Lewicki. Unsupervised classification, segmentation, de-noising of images using ica mixture models. IEEE Trans. on Image Processing, 11:270-279, 2002.
[21] M. Levoy, B. Chen, V. VAh, M. Horowitz, I. McDowall, and M. Bolas. Synthetic aperture confocal imaging. ACM Trans. Graphics, 23:825-834, 2004.
[22] Y. Li, A. Cichocki, and S. Amari. Analysis of sparse representation and blind source separation. Neural Computation, 16:1193-1234, 2004.
[23] D. Miyazaki and K. Ikeuchi. Inverse polarization raytracing: estimating surface shape of transparent objects. In Proc. IEEE Computer Soc. Conf. on Computer Vision and Pattern Recognition, volume 2, pages 910-917, 2005.
[26] S. G. Narasimhan, C. Wang, and S. K. Nayar. All the images of an outdoor scene. In European Conf. on Computer Vision, volume 2352 of LNCS, pages 148-162, 2002.
[27] S. Narasimhan, S. K. Nayar, B. Sun, and S. J. Koppal. Structured light in scattering media. Proc. IEEE Int. Conf. on Computer Vision, volume 1, pages 420-427, 2005.
[28] D. Nuzilland, S. Curila, and M. Curila. Blind separation in low frequencies using wavelet analysis, application to artificial vision. In Proc. ICA, pages 77-82, 2003.
[29] J. P. Oakley and B. L. Satherley. Improving image quality in poor visibility conditions using a physical model for contrast degradation. IEEE Trans. on Image Processing, 78:167-179, 1998.
[30] D. T. Pham and P. Garrat. Blind separation of a mixture of independent sources through a quasi-maximum likelihood approach. IEEE Trans. Signal Processing, 45:1712-1725, 1997.
[31] B. Sarel and M. Irani. Separating transparent layers through layer information exchange. In European Conf. on Computer Vision, volume 3024 of LNCS, pages 328-341, 2004.
[34] S. P. Schilders, X. S. Gan, and M. Gu. Resolution improvement in microscopic imaging through turbid media based on differential polarization gating. App. Opt., 37:4300-4302, 1998.
[35] N. Shashar, S. Sabbah, and T. W. Cronin. Transmission of linearly polarized light in sea water: implications for polarization signaling. Journal of Experimental Biology, 207:3619-3628, 2004.
[38] E. P. Simoncelli. Statistical models for images: Compression, restoration and synthesis. In Proc. IEEE Asilomar Conf. Sig. Sys. and Computers, pages 673-678, 1997.
[39] J. Sun, J. Jia, C. K. Tang, and H. Y. Shum. Poisson matting. ACM Trans. Graphics, 23:315-321, 2004.
[40] R. T. Tan and K. Ikeuchi. Separating reelection components of textured surfaces using a single image. IEEE Trans. on Pattern Analysis and Machine Intelligence, 27:178-193, 2005.
[41] T. Treibitz and Y. Y. Schechner. Instant 3Descatter. In Proc. IEEE Computer Soc. Conf. on Computer Vision and Pattern Recognition, volume 2, pages 1861-1868, 2006.
[42] J. S. Tyo, M. P. Rowe, E. N. Pugh Jr., and N. Engheta. Target detection in optically scattering media by polarization-difference imaging. App. Opt., 35:1855-1870, 1996.
[43] S. Umeyama and G. Godin. Separation of diffuse and specular components of surface reflection by use of polarization and statistical analysis of images. IEEE Trans. on Pattern Analysis and Machine Intelligence, 26:639-647, 2004.
[44] M. A. O. Vasilescu and D. Terzopoulos. Multilinear independent components analysis. In Proc. IEEE Computer Soc. Conf. on Computer Vision and Pattern Recognition, volume 1, pages 547-553, 2005.
[45] L. B. Wolff. Polarization vision: a new sensory approach to image understanding. Image & Vis. Comp., 15:81-93, 1997.
[46] K. M. Yemelyanov, S. S. Lin, E. N. Pugh, Jr., and N. Engheta. Adaptive algorithms for two-channel polarization sensing under various polarization statistics with nonuniform distributions. App. Opt., 45:5504-5520, 2006.
[47] M. Zibulevsky and B. A. Pearlmutter. Blind source separation by sparse decomposition in a signal dictionary. Neural Computations, 13:863-882, 2001.

### SUMMARY OF THE INVENTION

The present invention discloses an apparatus and methods for estimation and correcting distortions in caused by haze atmospheric in landscape images.

According to general scope of the current invention, a method of outdoor image correction is provided comprising the steps of: acquiring first image at first polarization state; acquiring second image at second polarization state, wherein said first and said second images overlap; estimating haze parameters from said first and second images; and correcting acquired image using said estimated haze parameters, wherein said estimating haze parameters from said first and second images does no rely on appearance of sky in the acquired images.

In some embodiments, the second polarization is essentially perpendicular to the first polarization. Preferably, the first polarization is chosen to essentially minimize the effect of atmospheric haze.

In other embodiments one state of the polarization comprises of partial polarization or no polarization.

According to an exemplary embodiment of the invention, the step of estimating haze parameter comprises the steps of: identifying at least two similar objects situated at known and substantially different distances zᵢ from the image-acquiring camera; and estimating haze parameters p and A_{∞} from image data associated with said objects and said known distances.

According to an exemplary embodiment of the invention the step of estimating haze parameters comprises blind estimation of the haze parameter p from analyzing high spatial frequency content of first and second images.

In some cases, analyzing high spatial frequency content of first and second images comprises wavelet analysis of said first and second images.

According to another exemplary embodiment of the invention the step of estimating haze parameters comprises using the estimated parameter p to estimate the haze parameter A_{∞}.

In some cases, using the estimated parameter p to estimate the haze parameter A_{∞} comprises identifying at least two locations situated at known and substantially different distances zᵢ from the image-acquiring camera.

In some cases using the estimated parameter p to estimate the haze parameter A_{∞} comprises identifying at least two similar objects situated at substantially different distances from the image-acquiring camera.

Another object of the invention is to provide system for of correcting scatter effects in an acquired image comprising: a first and second camera, wherein said first camera comprises a polarizer; and a computer receiving image data from said first and second camera, and uses parameters extracted from data acquired by first camera to correct an image acquired by said second camera.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show details of the invention in more detail than is necessary for a fundamental understanding of the invention, the description taken with the drawings making apparent to those skilled in the art how the several forms of the invention may be embodied in practice.

In the drawings:

FIG. 1 shows Dehazing of Scene:

FIG. 1(a) shows the best polarized raw image;

FIG. 1(b) shows the result of sky-based dehazing as used in the art;

FIG. 1(c) shows result of a feature-based method assisted by ICA according to one embodiment of the current invention;

FIG. 1(d) shows result of a distance-based method assisted by ICA according to another embodiment of the current invention;

FIG. 1(e) shows Distance-based result according to yet another embodiment of the current invention.

FIG. 2 schematically depicts the haze process and a system for acquiring and processing images according to an embodiment of the current invention.

FIG. 3 depicts the function G(V) at each color channel, corresponding to distances z₁=11 km and z₂=23 km in Scene 1.

FIG. 4 depicts the airlight map Â̂ corresponding to Scene 1.

FIG. 5 shows typical plots of Gₚ(V) based on Eq. (35).

FIG. 6 shows images of Scene 2;

FIG. 6(a) shows raw hazy image of Scene 2;

FIG. 6(b) shows Sky-based dehazing according to the method of the art;

FIG. 6(c) shows Feature-based dehazing assisted by ICA according to an embodiment of the current invention;

FIG. 6(d) Distance-based dehazing assisted by ICA according to another embodiment of the current invention;

FIG. 6(e) shows Distance-based result according to yet another embodiment of the current invention.

FIG. 7 demonstrates the negative correlation between the direct transmission \hat{D} and the airlight Â correspond to Scene 2 and also demonstrates that the wavelet channel of these images Â_{c}, \hat{D}_{c} are much less mutually dependent.

FIG. 8 shows a histogram of ρ, based on PDFs fitted to data of 5364 different images \tilde{D}_{c}, which were derived from various values of p, wavelet channels c and different raw images.

FIG. 9 shows histograms of \hat{p} across the wavelet channels, corresponding to FIG. 1.

FIG. 10 schematically depicting the method of image processing according to exemplary embodiments of the current invention.

FIG. 11 depicts a distance based estimation method for obtaining both parameters p and A_{∞} according to one embodiment of the current invention.

FIG. 12 depicts a blind estimation method for obtaining the global haze parameter p according to an embodiment of the current invention.

FIG. 13 depicts a distance based, known p estimation method for obtaining the global haze parameter A_{∞} according to one embodiment of the current invention.

FIG. 14 depicts a feature based, known p estimation method for obtaining the haze parameters A_{∞} according to an embodiment of the current invention.

FIG. 15 schematically depicts the stage of image correction according to an exemplary embodiment of the invention.

### DESCRIPTION OF THE PREFERRED EMBODIMENTS

The present invention relates to a devices methods and systems for polarization based approach for extracting parameters of airlight and attenuation due to haze from a pair of acquired images and using the extracted parameter for correcting the acquired image without the need for having a section of the sky in the image.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The drawings are generally not to scale. In discussion of the various figures described herein below, like numbers refer to like parts.

For clarity, non-essential elements and steps were omitted.

As used herein, an element or step recited in the singular and proceeded with the word “a” or “an” should be understood as not excluding plural elements or steps, unless such exclusion is explicitly recited.

The order of steps may be altered without departing from the general scope of the invention.

### DETAILED DESCRIPTION OF THE PREFERRED EMBODIMENTS

### A. Data Acquisition System

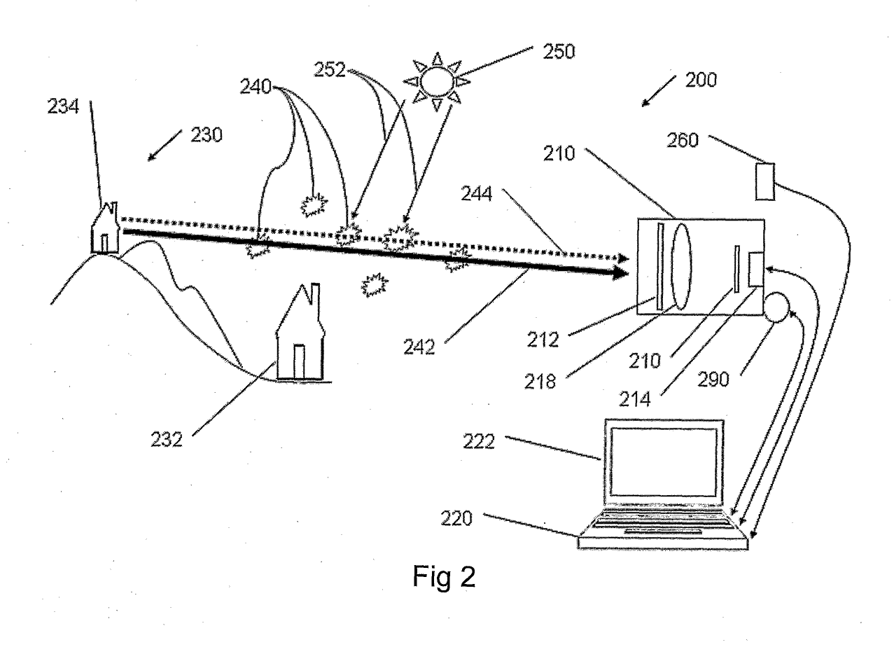

FIG. 2 schematically depicts the data acquisition and processing system 200. System 200 comprises a camera 210 and a computer 220.

Camera 210 is preferably a digital camera, however, a film based camera may be used provided that the film would be developed, scanned and digitize.

In order to obtain polarization depending images, a polarizer 212 is placed in the light path between the scenery 230 and the sensor 214.

Preferably, polarizer 212 is a linear polarizer mounted so its polarization axis can be rotated. According to the preferred embodiment of the invention, at least two images are acquired by camera 210 and transferred to computer 220 for analysis. Preferably, first image is taken when the polarization axis of polarization 212 is substantially such that maximum light impinges on sensor 214. A second image is acquired when the polarization axis of polarization 212 is substantially such that minimum light impinges on sensor 214, that is, when the polarization axis of polarizer 212 is substantially rotated by 90 degrees. In some embodiments, polarizer 212 is motorized. Optionally selection of first and second image is done automatically. Alternatively, an electronically controlled polarizer such as Liquid Crystal (LC) is used. Alternatively, a polarizing beam splitter may be used to split the light into two perpendicularly polarized images, each impinging of a separate sensor.

For color imaging, a color filter 216 is placed in front of sensor 214. Preferably, filter 216 is integrated into sensor 214. Alternatively, filter 216 may be a rotating filter wheel. Colors used are preferably be Red, Green and Blue (RGB), but other filter transmission bands such ad Near Infra Red (NIR) may be used.

Imaging unit 218 such as lens is used for imaging the light on the sensor. Preferably, sensor 214 is a pixilated 2-D sensor array such as Charge-Coupled Device (CCD) or another sensor array. Polarizer 212, filter 216 and lens 218 may be differently ordered along the optical path.

Optionally, polarizer 212 is integrated into the sensor 214. For example, some or all pixels in a pixilated sensor array may be associated with polarizers having different polarization states. For example, some of the pixels may be covered with a polarizing filters having different polarization axis. Additionally and alternatively, some pixels may be covered with polarizer having different degree of polarization efficiency. In some cases, some of the pixels are not covered with a polarizer.

Computer 220 may be a PC, a Laptop computer or a dedicated data processor and may be situated proximal to camera 210, in remote location or integrated into the camera. Data may be stored for off line analysis, or, displayed in real time. Display 220 is preferably used for viewing the processed image. Additionally or alternatively, the image may be printed. Optionally, processes and/or raw data may be transferred to remote location for further interpretation, for example further image processing.

Optionally, polarizer 112 is controlled by computer 220.

Optionally, distances from camera 210 to some of the imaged objects are provided by auxiliary unit 260. Auxiliary unit 260 may be a range finder such as laser range finder or radar based range finder or a map from which distances may be inferred. Additionally or alternatively, the distance to an object with a known size may be computed from its angular size on the image.

It should be noted that the current invention is not limited to visible light. Infra-Red (IR) camera may be used, having suitable sensor and imaging unit 218.

Imaging unit 118 may comprise diffractive, refractive and reflective elements. Optionally imaging unit 118 may have zoom capabilities. In some embodiments, zoom is controlled by computer 220.

In some embodiments camera 210 is remotely positioned.

In some embodiments, camera 210 is mounted of a stage 290. Stage 290 may be marks such that the direction of imaging may be measured and relayed to computer 220. In some embodiments, Stage 290 comprises directional sensor capable of measuring the direction of imaging. In some embodiments, stage 290 is motorized. In some embodiments, compute 220 controls the direction of imaging by issuing “pan” and/or “tilt” command to motorized stage 290.

Optionally, plurality of cameras is used.

For example, different cameras may be used for different spectral bends.

For example, different cameras may be used, each having different spatial resolution or different intensity resolution.

For example, different cameras may be used for imaging at different polarization states. Specifically, plurality of cameras may be used with different polarization states.

In some embodiments, the images taken for propose of extracting haze parameters needed for correcting the effects of scatter are different than the image to be corrected. It may be advantageous to include in the images taken for propose of extracting haze parameters objects that enable or ease the process of parameters extraction. For example, the observed area which needs to be corrected may be at substantially the same distance from the camera, or do not include known or similar objects. In this case, other images, comprising enough information needed to extract haze parameters may be used provided that parameters extracted from these images are relevant for the observed area. Parameters are slowly varying both spatially and in time, thus images taken in the general direction and under similar atmospheric conditions may be used.

For example, relatively wide angle lens may be used for propose of extracting haze parameters, while relatively telephoto lens is used for the image to be corrected.

For example, a different camera may be used for acquiring images for propose of extracting haze parameters.

Additionally or alternatively, images for propose of extracting haze parameters may be acquired periodically.

Additionally or alternatively, images for propose of extracting haze parameters may be acquired periodically at a different direction. For example in a direction including locations of known distance. For example, when auxiliary unit 260 is a range finder with limited range, and the region of observation is out of range, an image taken at closer range may be used for parameters extraction.

In some embodiments, digital image data is used for parameter extraction and is used to perform analog type image correction, for example in real time video viewing.

### B. Theoretical Rationalization for Data Analysis

1. Stray Radiation in Haze

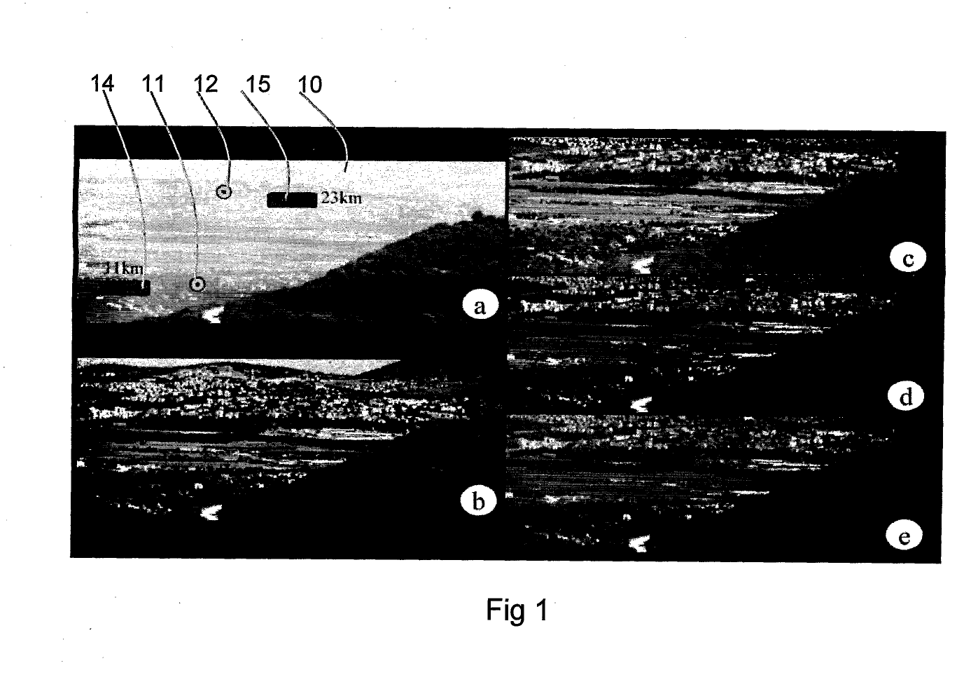

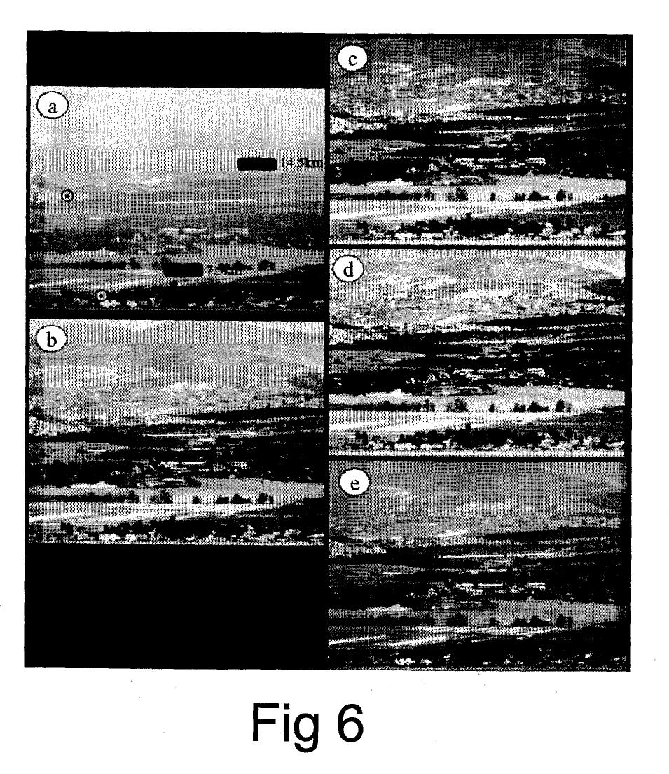

FIG. 1a shows an acquired image taken with digital camera on a hazy day. It should be noted that generally, viewing such images on a computer monitor better reviles the true colors and resolution of the enclosed small images of FIGS. 1 and 6.

For clarity of display, the images shown herein have undergone the same standard contrast stretch. This contrast stretch operation was done only towards the display. The methods according to the invention were performed on raw, un-stretched data. The data had been acquired using a Nikon D-100 camera, which has a linear radiometric response. The methods of the current invention are not restricted to high quality images and may be useful for correcting images such as acquired by a digitized video camera. However, it is preferred to perform these methods on images acquired by a high dynamic range imager having a 10-bit resolution or more. Bit resolution of a camera my be improved by averaging or summing plurality of images.

The reduced contrast and color distortion is clearly seen in FIG. 1a, specifically for scenery at larger distances of 11 and 23 km as indicated in the figure.

For comparison, FIG. 1b. shows the sky-based dehazing result of the acquired FIG. 1a. According to the method known in the art as detailed in references [24, 33] A small section of sky 10 is seen at the top of FIG. 1a and was used for the sky-based dehazing.

The parameter estimation of the sky-based dehazing relies, thus, on the existence of sky 10 in the Field Of View (FOV). This reliance has been a limiting factor, which inhibited the usefulness of that approach. Often, the FOV does not include a sky area. This occurs, for example, when viewing from a high vantage point, when the FOV is narrow, or when there is partial cloud cover in the horizon.

The methods according to embodiments of the current invention address this problem, i.e., enable successful dehazing despite the absence of sky in the FOV. Moreover, a method is provided that blindly separates the airlight radiance (the main cause for contrast degradation) from the object's signal.

According to the embodiments of the current invention, the parameter that determines this separation is estimated without any user interaction. The method exploits mathematical tools developed in the field of blind source separation (BSS), also known as independent component analysis (ICA).

ICA has already contributed to solving image separation [12, 31, 37, 43] problems, and high-level vision [10, 20, 44] particularly with regard to reflections. The problem of haze is more complex than reflections, since object recovery is obtained by nonlinear interaction of the raw images. Moreover, the assumption of independence upon which ICA relies is not trivial to accommodate as we later explain. Nevertheless, we show that the radiance of haze (airlight) can be separated by ICA, by the use of a simple pre-process. Dehazing had been attempted by ICA based on color cues [28]. However, an implicit underlying assumption behind Ref. [28] is that radiance is identical in all the color channels, i.e. the scene is gray. This is untypical in nature.

The method described in this paper is physics-based, rather than being pure ICA of mathematically abstract signals. Thanks to this approach to the problem, common ICA ambiguities are avoided. We successfully performed skyless dehazing in multiple real experiments conducted in haze. We obtained blind parameter estimation which was consistent with direct sky measurements. Partial results were presented in Ref. [36].

2. Theoretical Background

To make the explanation self-contained, this section briefly reviews the known formation model of hazy images. It also describes a known inversion process of this model, which recovers good visibility. This description is based on Ref. [33]. As shown in FIG. 2, an acquired frame is a combination of two main components. The first originates from the object radiance and depicted in FIG. 2 as heavy arrow 242 leading from an object 234 to camera 210. Let us denote by L^{object} the object radiance as if it was taken in a clear atmosphere, without scattering or absorption in the Line Of Sight (LOS). Due to atmospheric attenuation and scattering, schematically depicted in FIG. 2 as perturbation centers 240, the camera senses a fraction of this radiance. The disclosed invention may be used for correcting images taken trough any turbid media; fluid or solid; such as blood, or biological tissue using natural or artificial illumination. Perturbation centers 240 may be particles suspended in the air (or water for underwater imaging), water droplets such as fog or statistical density fluctuations in the atmosphere. This attenuated signal is the direct transmission

D=L^{object}t (1)

where

t=e^{-βz} (2)

t is the transmittance of the atmosphere. The transmittance depends on the distance z between the object and the camera, and on the atmospheric attenuation coefficient β. where ∞>β>0.

The second component is known as path radiance, or airlight. It originates from the scene illumination (e.g., sunlight), a portion of which is scattered into the LOS by the haze.

Ambient light, schematically depicted by thin arrows 252, animating from illumination source 250, for example the sun (but may be an artificial light source) is scattered towards the camera by atmospheric perturbations 240, creating airlight A, depicted ad dashed arrow 244. Airlight increases with object distance.

Let a(z) be the contribution to airlight from scattering at z, accounting for attenuation this component undergoes due to propagation in the medium. The aggregate of a(z) yields the airlight

$$A = {\int }_{0}^{z} a ( {z}^{′} ) d {z}^{′} = {A}_{∞} ( 1 - t ) \qquad ( 3 )$$

Here A_{∞} the value of airlight at a non-occluded horizon. It depends on the haze and illumination conditions. Contrary to the direct transmission, airlight increases with the distance and dominates the acquired image irradiance

I^{total}=D+A (4)

at long range. The addition of airlight [1] is a major cause for reduction of signal contrast.

In haze, the airlight is often partially polarized. Hence, the airlight image component can be modulated by a mounted polarizer. At one polarizer orientation the airlight contribution is least intense. Since the airlight disturbance is minimal here, this is the best state of the polarizer. Denote this airlight component as A^{min}. There is another polarizer orientation (perpendicular to the former), for which the airlight contribution is the strongest, and denoted as A^{max}. The overall airlight given in (Eq. 3) is given by

A=A^{min}+A^{max}. (5)

Assuming that the direct transmission is not polarized, the energy of D is equally split among the two polarizer states. This assumption is generally justified and departure cause only minor degradation. Hence, the overall measured intensities at the polarizer orientations mentioned above are

I^{min}=A^{min}+D/2; I^{max}=A^{max}+D/2. (6)

The Degree Of Polarization (DOP) of the airlight is defined as

p=(A^{max}−A^{min})/A, (7),

where A is given in Eq. (3). For narrow FOVs, this parameter does not vary much. In this work we assume that p is laterally invariant. Eq. (7) refers to the aggregate airlight, integrated over the LOS.

It should be noted that in the context of this invention, “polarization” or “polarization states” refers to difference in the state of polarizer 218 which affects a change in the acquired image. The indications “min” and “max” refers to sates with smaller and larger signals caused by the scattered light and not necessarily the absolute minimum and maximum of these contributions.

For example, I^{min} may refer to a polarization state that is not exactly minimize the scattered radiation. As another example, I^{min} may refer to an image taken with no polarization at all. In this context, the polarization parameter “p” means an “effective” polarization parameter associated to the ration of the scattered light in the different polarization states.

It should also be noted that by acquiring three or more images at substantially different linear polarization states, the signals associated with extremes states of polarization may be inferred. For example, three images may be taken at 0, 45 and 90 degrees to an arbitrary axis, wherein this axis do not necessarily coincides with the extreme effect on the scattered light. The foundation for this method may be found in ref [48]; Yoav Y. Schechner, Srinivasa G. Narasimhan and Shree K. Nayar; “Instant Dehazing of Images Using Polarization”; Proc. Computer Vision & Pattern Recognition Vol. 1, pp. 325-332 (2001).

Is p invariant to distance? Implicitly, this would mean that the DOP of a(z) is unaffected by distance. This is not strictly true. Underwater, it has recently been shown [35] that the DOP of light emanating from z may decay with z. This may also be the case in haze, due to multiple scattering. Multiple scattering also causes blur of D. For simplicity, we neglect the consequence of multiple scattering (including blur), as an effective first order approximation, as in Refs. [24, 33]. Note that

0≦p≦1 (8)

It follows that

I^{min}=A(1−p)/2+D/2, I^{max}=A(1+p)/2+D/2. (9)

It is easy to see from Eqs. (4,9) that

Î^{total}=I^{min}+I^{max} (10)

Dehazing is performed by inverting the image formation process. The first step separates the haze radiance (airlight) A from the object's direct transmission D. The airlight is estimated as

Â=(I^{max}−I^{min})/p (11)

Then, Eq. (4) is inverted to estimate D. Subsequently, Eq. (1) is inverted based on an estimate of the transmittance (following Eq. 3)

\hat{t}=1−Â/A_{∞} (12)

These operations are compounded to dehazing

\hat{L}^{object}=(I^{total}−Â)/\hat{t} (13)

Two problems exist in this process. First, the estimation (i.e., separation) of airlight requires the parameter p. Secondly, compensation for attenuation requires the parameter A_{∞}. Both of these parameters are generally unknown, and thus provide the incentive for this invention. In past dehazing work, these parameters were estimated based on pixels which correspond to the sky near the horizon.

A method to recover the object radiance L^{object} when the sky is unseen was theoretically proposed in Ref. [33]. It required the presence in the FOV of at least two different classes of multiple objects, each class having a similar (unknown) radiance in the absence of haze.

For example, the classes can be buildings and trees. However, we found that method to be impractical. It can be difficult to identify two sets, each having a distinct class of similar objects. Actually, sometimes scenes do not have two such classes. Moreover, to ensure a significant difference between the classes, one should be darker than the other.

However, estimating the parameter based on dark objects is prone to error caused by noise. Therefore, in practical tests, we found the theoretical skyless possibility mentioned in Ref. [33] to be impractical.

In the context of this invention, similar objects may be objects or areas in the image, having a known ration of object radiance, that is: Lₖ^{object}=ηLₘ^{object} wherein η is a known ratio between radiance of objects k and m. It should be noted that similar objects are defined by this property and not necessarily by their nature. A non-limiting example of similar objects is a class of objects having same physical nature, such as similar structures or nature. For example, similar objects may be roads, buildings etc. In that case it is likely that η=1.

However, similar objects may be chosen as a road and a building, as long as the value or r is known. In some cases, the value of r is extracted from acquired images, for example images taken on haze-less day, images taken at short distance, images corrected by a different dehazing method, etc. Alternatively, the ratio r may be known from identification of the types of objects and prior knowledge about their optical properties.

It should be noted that the similar object may be a compost object spanning plurality of image pixel or having non uniform radiance but with characteristic radiance. For example, a building may comprise of darker windows. In that case, an average radiance may be used. Alternatively, dark windows may be excluded from the values representing the building.

3. Skyless Dehazing

This section introduces several methods to recover the scene radiance, when the sky is not in view according to some embodiments of the invention. They estimate the parameters p and A_{∞} in different ways. The method presented in Sec. 3.1 requires one class of objects residing at different distances. The consecutive methods, presented in sections 3.2 and 3.3, assume that the parameter p is known. This parameter can be blindly derived by a method described in Sec. 4. Consequently, there is reduction of the information needed about objects and their distances. The method presented in Sec. 3.2 only requires the relative distance of two areas in the FOV, regardless of their underlying objects. The method described in Sec. 3.3 requires two similar objects situated at different, but not necessarily known distances. Table 1 summarizes the requirements of each of these novel methods.

TABLE 1
The requirements of prior knowledge in the different
methods.

| | Similar objects | Known distances | Known P (section 4) |
|---|---|---|---|
| Section | required? | required? | required? |
| 3.1 | yes | Yes | no |
| | | (relative) | |
| 3.2 | no | yes | yes |
| 3.3 | yes | no | yes |

3.1 Distance and Radiance Based Dehazing

In this section, a method is developed for estimating p and A_{∞} based on known distances to similar objects in the FOV. Suppose we can mark two scene points: (xₖ, yₖ), k=1,2, which, in the absence of scattering, would have a similar (unknown) radiance. For example, these can be two similar buildings which have an unknown radiance L^{build}. The points, however, should be at different distances from the camera z₂>z₁.

For example, the two circles 11 and 12 in FIG. 1a. correspond to two buildings, situated at known distances of 11 km and 23 km. Using Eqs. (1,2,3,6), the image values corresponding to the object at distance z₁ are

$${I}_{1}^{max} = \frac{{L}^{build}}{2} {e}^{- β {z}_{1}} + {A}_{∞}^{max} ( 1 - {e}^{- β {z}_{1}} ) , \\ {I}_{1}^{min} = \frac{{L}^{build}}{2} {e}^{- β {z}_{1}} + {A}_{∞}^{min} ( 1 - {e}^{- β {z}_{1}} ) \qquad ( 15 )$$

Similarly, for the object at distance z₂,

$$\begin{matrix}{I}_{2}^{max} = \frac{{L}^{build}}{2} {e}^{- β {z}_{2}} + {A}_{∞}^{max} ( 1 - {e}^{- β {z}_{2}} ) , & ( 16 ) \\ {I}_{2}^{min} = \frac{{L}^{build}}{2} {e}^{- β {z}_{2}} + {A}_{∞}^{min} ( 1 - {e}^{- β {z}_{2}} ) . & ( 17 )\end{matrix}$$

Let us denote

C₁=I₁^{max}−I₁^{min}, C₂=I₂^{max}−I₂^{min}. (18)

It can be shown that C₂>C₁. Note that since Iₖ^{max} and Iₖ^{min} are the data at coordinates in the FOV, then C₁ and C₂ are known.

Now, from Eqs. (14,15)

$$\frac{{C}_{1}}{( 1 - {V}^{{z}_{1}} )} = {A}_{∞}^{max} - {A}_{∞}^{min} , \qquad ( 19 )$$

while Eqs. (16,17) yield

$$\frac{{C}_{2}}{( 1 - {V}^{{z}_{2}} )} = {A}_{∞}^{max} - {A}_{∞}^{min} , \qquad ( 20 )$$

where

V≡e^{-β} (21)

Dividing Eq. (19) by Eq. (20) yields the following constraint

G(V)≡C₁V^{z}^{₂}−C₂V^{z}^{₁}+(C₂−C₁)=0 (22)

Let a zero crossing of G(V) be at V₀. We now show that based on this V₀, it is possible to estimate p and A_{∞}. Then, we prove the existence and uniqueness of V₀.

The parameters estimation is done in the following way. It can be shown that

(I₁^{max}+I₁^{min})=L^{build}V^{z}^{₁}+(A_{∞}^{max}+A_{∞}^{min})(1−V^{z}^{₁}), (23)

and

(I₂^{max}+I₂^{min})=L^{build}V^{z}^{₂}+(A_{∞}^{max}+A_{∞}^{min})(1−V^{z}^{₂}). (24)

Following Eqs. (5,23,24), an estimate for A_{∞} obtained by

$${\hat{A}}_{∞} = ( {A}_{∞}^{max} + {A}_{∞}^{min} ) = \frac{( {I}_{2}^{max} + {I}_{2}^{min} ) {V}_{0}^{{z}_{1}} - ( {I}_{1}^{max} + {I}_{1}^{min} ) {V}_{0}^{{z}_{2}}}{{V}_{0}^{{z}_{1}} - {V}_{0}^{{z}_{2}}} . \qquad ( 25 )$$

Based on Eqs. (14,15), define

$$Δ A ≡ {A}_{∞}^{max} - {A}_{∞}^{min} = \frac{{I}_{1}^{max} - {I}_{1}^{min}}{1 - {V}_{0}^{{z}_{1}}} . \qquad ( 26 )$$

Using Eqs. (7,25,26),

$$\hat{p} = \frac{Δ A}{{\hat{A}}_{∞}} \qquad ( 27 )$$

Thus, Eqs. (25,26,27) recover the required parameters p and A_{∞}. Two known distances of similar objects in the FOV are all that is required to perform this method of dehazing, when the sky is not available.

Let us now prove the existence and uniqueness of V₀.
Recall that ∞>β>0., therefore 0<V<1 (Eq. 21).
G|_{V=0}>0, since C₂>C₁.
G|_{V=1}=0. This root of G is not in the domain.
The function G(V) has only one extremum. The reason is that its derivative

$$\frac{\partial G}{\partial V} = {z}_{2} {C}_{1} {V}^{{z}_{2} - 1} - {z}_{1} {C}_{2} {V}^{{z}_{1} - 1} \qquad ( 28 )$$

is null only when

$$V = {( \frac{{z}_{1} {C}_{2}}{{z}_{2} {C}_{1}} )}^{\frac{1}{( {z}_{2} - {z}_{1} )}} . \qquad ( 29 )$$

This extremum is a minimum. It can be shown that ∂²G/∂V²>0.

Due to these facts, Eq. (22) always has a unique root at V0ε(0, 1).

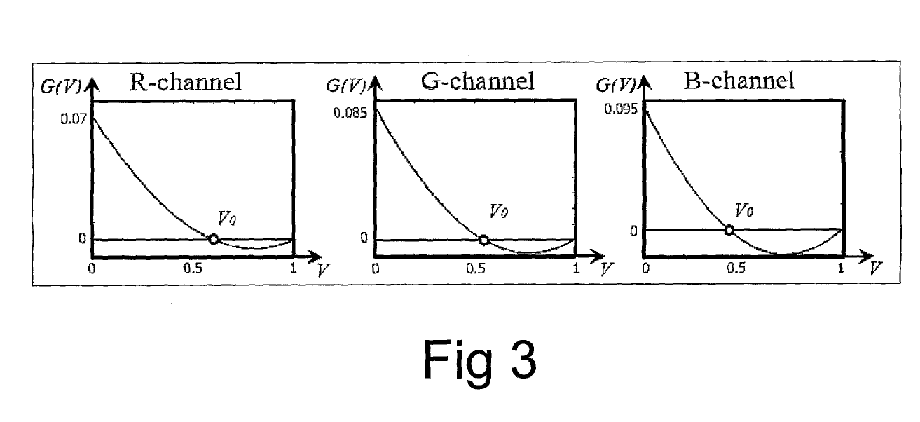

A typical plots of G(V) are shown in FIG. 3.

FIG. 3 depicts the function G(V) at each color channel, corresponding to distances z₁=11 km and z₂=23 km in Scene 1. Note that G|_{V=0}>0 and G|_{V=1}=0. Since G(V) has a single minima, it has only a single root in the domain Vε(0, 1).

Due to the simplicity of the function G(V), it is very easy to find V₀ for example using standard Matlab tools or other methods known in the art.

The solution V₀ can be found when z₁ and z₂ are known, or even only relatively known.

It is possible to estimate the parameters A_{∞} and p based only on the relative distance \tilde{z}=z₂/z₁, rather than absolute ones. For example, in FIG. 1a, \tilde{z}=2:091. Denote

\tilde{V}=V^{z}^{₁}=e^{-βz}^{₁}. (30)

Then, Eq. (22) is equivalent to the constraint

\tilde{G}(V)≡C₁\tilde{V}^{\tilde{z}}−C₂\tilde{V}+(C₂−C₁)=0. (30)

Similarly to Eq. (22), Eq. (31) also has a unique \tilde{V}₀ε(0, 1). root at Hence, deriving the parameters is done similarly to Eqs. (25,26,27). Based on \tilde{V}₀, A_{∞} estimated as

$${\hat{A}}_{∞} = \frac{( {I}_{2}^{max} + {I}_{2}^{min} ) {\tilde{V}}_{0} - ( {I}_{1}^{max} + {I}_{1}^{min} ) {\tilde{V}}_{0}^{\tilde{z}}}{{\tilde{V}}_{0} - {\tilde{V}}_{0}^{\tilde{z}}} . \qquad ( 32 ) .$$

Similarly to Eq. (26),

$$Δ A = \frac{{I}_{1}^{max} - {I}_{1}^{min}}{1 - {\tilde{V}}_{0}} . \qquad ( 33 )$$

Then, Eq. (27) yields \hat{p}

Based on these parameters, Eqs. (11,12) yield Â(x, y) and \hat{t}(x, y). Then \hat{L}^{object}(X, y) is derived using Eq. (13), for the entire FOV. This dehazing method was applied to Scene 1, as shown in FIG. 1e. Indeed, the haze is removed, and the colors are significantly recovered, relative to the raw image shown in FIG. 1a. There is a minor difference between FIGS. 1b and 1e.

The absolute distances z₁, z₂ or their ratio \tilde{z} can be determined in various ways. One option is to use a map (this can be automatically done using a digital map), assuming the camera location is known). Relative distance can be estimated using the apparent ratio of two similar features that are situated at different distances. Furthermore, the absolute distance can be determined based on the typical size of objects.

3.1.1 Unequal Radiance

The analysis can be extended to the case where the similar objects used for calibration of parameters do not have the same radiance, but the ratio of their radiance is known. Suppose the object at z₁ has radiance L^{build}, and the object at z₂ has radiance ηL^{build}. Then, Eqs (16,17) may be re-written as

$$\begin{matrix}{I}_{2}^{max} = η \frac{{L}^{build}}{2} {e}^{- β {z}_{2}} + {A}_{∞}^{max} ( 1 - {e}^{- β {z}_{2}} ) , & ( {16}^{*} ) \\ {I}_{2}^{min} = η \frac{{L}^{build}}{2} {e}^{- β {z}_{2}} + {A}_{∞}^{min} ( 1 - {e}^{- β {z}_{2}} ) . & ( {17}^{*} )\end{matrix}$$

We maintain the definitions of Eq. (18) unchanged. It is easy to show that Eqs. (19,20,21,22, 23) are not affected by the introduction of η. Hence, the estimation of V0 (and thus β) is invariant to η, even if η is unknown.

Eq. (24) becomes

(1/η)(I₂^{max}+I₂^{min})=L^{build}V^{z}^{₂}+(1/η)(A_{∞}^{max}+A_{∞}^{min})(1−V^{z}^{₂}). (24*)

Now suppose that η is approximately known, e.g., by photographing these points in very clear conditions, or from very close distances. Then, based on Eqs. (23,36), and using the found V₀, The expression analogous to Eq. (25) is

$${\hat{A}}_{∞} = \frac{( 1 / η ) ( {I}_{2}^{max} + {I}_{2}^{min} ) {V}_{0}^{{z}_{1}} - ( {I}_{1}^{max} + {I}_{1}^{min} ) {V}_{0}^{{z}_{2}}}{[ ( 1 / η ) {V}_{0}^{{z}_{1}} - {V}_{0}^{{z}_{2}} ] + {V}_{0}^{( {z}_{1} + {z}_{2} )} ( 1 - 1 / η )} . \qquad ( {25}^{*} )$$

This equation degenerates to Eq. (25) in the special case of =1. From this result of Â_{∞}, Eqs. (26, 27) remain unchanged, and the estimation of p does not need to be effected by η.

A similar derivation applies to the case where only the relative distances are known. Then, Eqs. (30, 31) are not affected by the introduction of Hence, the estimation of \tilde{V}₀ is invariant to η, even if η is unknown. Then, the expression analogous to Eq. (32) is

$${\hat{A}}_{∞} = \frac{( 1 / η ) ( {I}_{2}^{max} + {I}_{2}^{min} ) {\tilde{V}}_{0} - ( {I}_{1}^{max} + {I}_{1}^{min} ) {\tilde{V}}_{0}^{\tilde{z}}}{[ ( 1 / η ) {\tilde{V}}_{0} - {\tilde{V}}_{0}^{\tilde{z}} ] + {V}_{0}^{( 1 + \tilde{z} )} ( 1 - 1 / η )} . \qquad ( {32}^{*} )$$

This equation degenerates to Eq. (32) in the special case of η=1. From this result of Â_{∞}, Eq. (33) remains unchanged, and the estimation of p does not need to be affected by η′.

3.1.2 Objects that May be at the Same Distance

Parameter calibration can even be made when the objects are at the same distance z, i.e., when \hat{z}=1. This is possible if η≠1. In this case, Eq. (38) becomes

$$\begin{matrix}{\hat{A}}_{∞} = \frac{( 1 / η ) ( {I}_{2}^{max} + {I}_{2}^{min} ) - ( {I}_{1}^{max} + {I}_{1}^{min} )}{[ ( 1 / η ) - 1 ] + {\tilde{V}}_{0} ( 1 - 1 / η )} \\ = \frac{( 1 / η ) {I}_{2}^{total} - {I}_{1}^{total}}{[ ( 1 / η ) - 1 ] + {\tilde{V}}_{0} ( 1 - 1 / η )} .\end{matrix} \qquad ( {39}^{*} )$$

It is solvable as long as \tilde{V}₀≠1 i.e., the distance is not too close and the medium is not completely clear, and as long as η≠0. It can be re-formulated as

$${\tilde{V}}_{0} = 1 - [ \frac{( 1 / η ) {I}_{2}^{total} - {I}_{1}^{total}}{( 1 / η ) - 1} ] \frac{1}{{A}_{∞}} . \qquad ( {40}^{*} )$$

Hence there is a linear relation between \tilde{V}₀ and the sought 1/A_{∞}. To solve for Â_{∞} we must have an estimate of \tilde{V}₀. There are various ways to achieve this. First, suppose that there is another object point at the same distance. Its measured intensity is I₃^{total}≠I₂^{total}, and its radiance (when there is no scattering medium) is χL^{build}, where χ≠η is known.

Here,

$${\tilde{V}}_{0} = 1 - [ \frac{( 1 / χ ) {I}_{3}^{total} - {I}_{1}^{total}}{( 1 / χ ) - 1} ] \frac{1}{{A}_{∞}} , \qquad ( {41}^{*} )$$

which is a different linear relation between \tilde{V}₀ and the sought 1/A_{∞}. The intersection of Eqs. (40*,41*) yields both Â_{∞} and \tilde{V}₀. Then, Eqs. (33,27) yield \hat{p}.

There are other possibilities to solve for A_{∞}. For instance, suppose that we use only two objects, but we know or set L^{build}. This can occur, for example, when we wish that a certain building would be recovered such that it has a certain color L^{build}. Then, Eq. (23) becomes

I₁^{total}=L^{build}\tilde{V}+A_{∞}(1−\tilde{V}), (42*)

while Eq. (36) becomes

(1/η)I₂^{total}=L^{build}\tilde{V}+(1/η)A_{∞}(1−\tilde{V}). (43*)

Eqs. (42*,43*) are two equations, which can be solved for the two unknowns \tilde{V}₀ and A_{∞} yielding Â_{∞} and \tilde{V}₀.

3.2 Distance-Based, Known p

In some cases, similar objects at known distances may not exist in the FOV, or may be hard to find. Then, we cannot use the method presented in Sec. 3.1. In this section we overcome this problem, by considering two regions at different distances z₁<z₂, regardless of the underlying objects. Therefore, having knowledge of two distances of arbitrary areas is sufficient. The approach assumes that the parameter p is known. This knowledge may be obtained by a method described in Sec. 4, which is based on ICA.

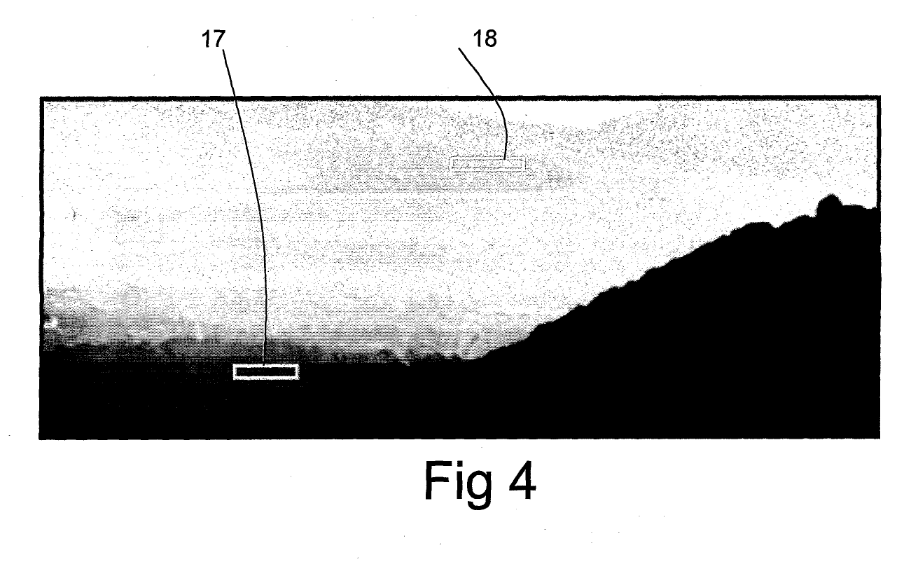

Based on a known p and on Eq. (11), Â is derived for every coordinate in the FOV. As an example, the estimated airlight map Â corresponding to Scene 1 is shown in FIG. 4.

FIG. 4 depicts the airlight map Â corresponding to Scene 1.

The two rectangles 17 and 18 represent two regions, situated at distances z₁ and z₂ respectively. Note that unlike Sec. 3.1, there is no demand for the regions to correspond to similar objects.

From Eqs. (2,12),

$${e}^{- β z} = 1 - \frac{\hat{A}}{{A}_{∞}} . \qquad ( 34 )$$

For regions around image coordinates (x₁,y₁) and (x₂,y2) having respective distances z₁ and z₂, Eq. (34) can be written as

$${V}^{{z}_{1}} = 1 - \frac{\ddot{A} ( {x}_{1} , {y}_{1} )}{{A}_{∞}} , {V}^{{z}_{2}} = 1 - \frac{\ddot{A} ( {x}_{2} , {y}_{2} )}{{A}_{∞}} , \qquad ( 35 )$$

where V is defined in Eq. (21). It follows from Eq. (35) that

A_{∞}(V^{z}^{₁}−V^{z}^{₂})=Â(x₂,y₂)−Â(x₁,y₁) (36)

and

A_{∞}(2−V^{z}^{₁}−V^{z}^{₂})=Â(x₂,y₂)+Â(x₁,y₁). (37)

Dividing Eq. (36) by Eq. (37) yields the following constraint

Gₚ(V)≡(α−1)V^{z}^{₂}+(α+1)V^{z}^{₁}−2α=0, (38)

where

$$α = \frac{\hat{A} ( {x}_{2} , {y}_{2} ) - \hat{A} ( {x}_{1} , {y}_{1} )}{\hat{A} ( {x}_{2} , {y}_{2} ) + \hat{A} ( {x}_{1} , {y}_{1} )} . \qquad ( 39 )$$

Recall that Â is known here (since p is known), hence α can be calculated. Since z₁<z₂, Then α>0.

Similarly to (22), Eq. (38) has a unique solution at V₀ε(0, 1). Let us prove the existence and uniqueness of V₀.
Recall that ∞>β>0 Hence 0<V<1 (Eq. 21).
Gₚ|_{V=0}<0, since (−2α)<0
ₚG|_{V=1}=0. This root of Gₚ is not in the domain.
The function Gₚ(V) has only one extremum: its derivative is null only once.
This extremum is a maximum. It can be shown ∂²Gₚ/∂V²<0. that

Due to these facts, Eq. (38) has a unique root at V₀ε(0, 1).

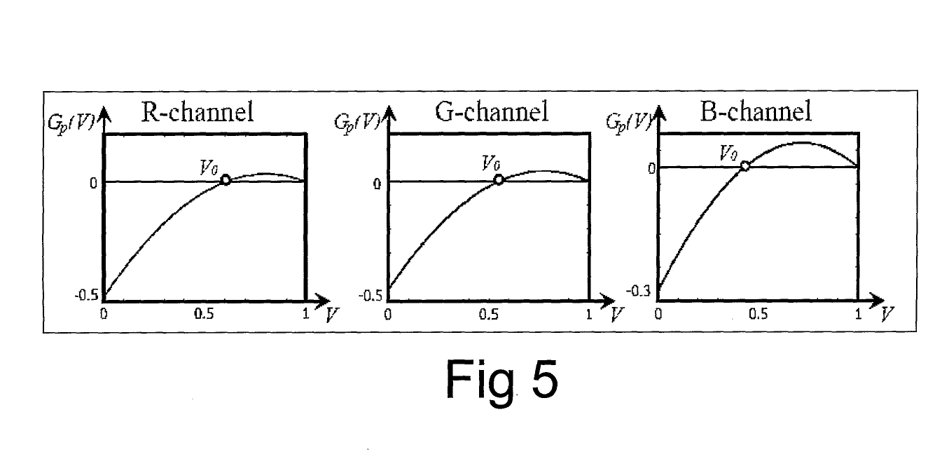

Typical plots of Gₚ(V) are shown in FIG. 5. Based on Eq. (35),

$${\hat{A}}_{∞} = \frac{\hat{A} ( {x}_{1} , {y}_{1} )}{1 - {V}_{0}^{{z}_{1}}} . \qquad ( 40 )$$

Similarly to Sec. 3.1, it is possible to estimate A_{∞} based only on the relative distance \hat{z}=z₂/z₁, rather than absolute ones. Then,

\tilde{G}ₚ(\tilde{V})≡(α−1)\tilde{V}^{\tilde{z}}+(α+1)\tilde{V}−2α=0, (41)

where \tilde{V} defined in (30). Eq. (41) has a unique solution \tilde{V}ε(0, 1). Based on Eqs. (35),

$${\hat{A}}_{∞} = \frac{\ddot{A} ( {x}_{1} , {y}_{1} )}{1 - {\tilde{V}}_{0}} . \qquad ( 42 )$$

FIG. 5 shows the function Gₚ(V) at each color channel, corresponding to distances z₁=11 km and z₂=23 km in Scene 1. Note that Gₚ|_{V=0}<0 and Gₚ|_{V=1}=0. Since Gₚ(V) has a single maximum, it has only a single root in the domain Vε(0, 1).

This dehazing method was applied to Scene 1, as shown in FIG. 1d.

3.3 Feature-Based, Known p

In this section discloses a method according to an embodiment of the invention to estimate A_{∞}, based on identification of two similar objects in the scene. As in Sec. 3.1, these can be two similar buildings which have an unknown radiance L^{build}. Contrary to Sec. 3.1, the distances to these objects are not necessarily known. Nevertheless, these distances should be different. As in Sec. 3.2, this method is based on a given estimate of \hat{p}, obtained, say, by the BSS method of Sec. 4. thus, an estimate of Â(x, y) is at hand.

It is easy to show [33] from Eqs. (11, 12, 13) that

Iₖ^{total}=L^{build}+S^{build}Â(xₖ,yₖ), (43)

where

S^{build}≡(1−L^{build}/A_{∞}) (44)

is a constant.

Buildings at different distances have different intensity readouts, due to the effects of scattering and absorption. Therefore, they have different values of Î^{total} and A. According to Eq. (43), Î^{total} as a function of Â forms a straight line. Such a line can be determined using two data points. Extrapolating the line, its intercept yields the estimated radiance value \hat{L}^{build}. Let the slope of the fitted line be S^{build}. We can now estimate A_{∞}, as

Â_{∞}=\hat{L}^{build}/(1−S^{build}). (45)

Based on Â_{∞} and \hat{p}, we can recover \hat{L}^{object}(x, y) for all pixels, as explained in Sec. 3.1.

As an example, the two circles 11 an 12 in FIG. 1a. mark two buildings residing at different distances.

The values of these distances are ignored, as if they are unknown. The corresponding dehazing result is shown in FIG. 1c.

Unequal Radiance

The analysis can be extended to the case where the similar objects used for calibration of parameters do not have the same radiance, but the ratio of their radiance is known in ways similar to the treatment given in section 3.1.

4. Blind Estimation of p

Both Secs. 3.2, 3.3 assume that the parameter p is known. In this section, according to an embodiment of the invention, a method is developed for blindly estimating p based on low-level vision. First, note that Eq. (13) can be rewritten as

$${\hat{L}}^{object} = \frac{( 1 - 1 / p ) {I}^{max} ( x , y ) + ( 1 + 1 / p ) {I}^{min} ( x , y )}{1 - [ {I}^{max} ( x , y ) - {I}^{min} ( x , y ) ] / ( {A}_{∞} p )} . \qquad ( 46 )$$

This is a nonlinear function of the raw images I^{max} and I^{min}, since they appear in the denominator, rather than just superimposing in the numerator. However, the image model illustrated in FIG. 2 has a linear spect: in Eqs. (4,10), the sum of the two acquired images I^{max}, I^{min} is equivalent to a linear mixture of two components, A and D. This linear interaction makes it easy to use tools that have been developed in the field of ICA for linear separation problems. This section describes our BSS method for hazy images, and reveals some insights. The result of this BSS yields \hat{p}.

4.1 Facilitating Linear ICA

To facilitate linear ICA, we attempt to separate A(x, y) from D(x, y). However, there is a problem: as we detail in this section, ICA relies on independence of A and D.

This assumption is questionable in our context. Thus, we describe a transformation that enhances the reliability of this assumption.

From Eq. (9), the two acquired images constitute the following equation system:

$$\begin{matrix}[ \begin{matrix}{I}^{max} \\ {I}^{min}\end{matrix} ] = M [ \begin{matrix}A \\ D\end{matrix} ] , \\ where & ( 47 ) \\ M = [ \begin{matrix}( 1 + p ) / 2 & 1 / 2 \\ ( 1 - p ) / 2 & 1 / 2\end{matrix} ] . & ( 48 )\end{matrix}$$

Thus, the estimated components are

$$\begin{matrix}[ \begin{matrix}\hat{A} \\ \hat{D}\end{matrix} ] = W [ \begin{matrix}{I}^{max} \\ {I}^{min}\end{matrix} ] , \\ where & ( 49 ) \\ W = [ \begin{matrix}1 / p & - 1 / p \\ ( p - 1 ) / p & ( p + 1 ) / p\end{matrix} ] . & ( 50 )\end{matrix}$$

Eqs. (47, 49) are in the form used by linear ICA. Since p is unknown, then the mixing matrix M and separation matrix W are unknown. The goal of ICA in this context is: given only the acquired images I^{max} and I^{min}, find the separation matrix W that yields “good” Â and \hat{D}. A quality criterion must be defined and optimized. Typically, ICA would seek Â and \hat{D} that are statistically independent (see [3, 5, 15, 30]). Thus, ICA assumes independence of A and D. However, this is a wrong assumption. The airlight A always increases with the distance z, while the direct transmission D decays, in general, with z.

Thus, there is a strong negative correlation between A and D.

To observe this, consider the hazy Scene 2, shown in FIG. 6.

FIG. 6 shows images of Scene 2.: FIG. 6(a) shows raw hazy image of Scene 2. FIG. 6(b) shows Sky-based dehazing according to the method of the art. FIG. 6(c) shows Feature-based dehazing assisted by ICA according to an embodiment of the current invention. FIG. 6(d) Distance-based dehazing assisted by ICA according to another embodiment of the current invention. And FIG. 6(e) shows Distance-based result according to yet another embodiment of the current invention.

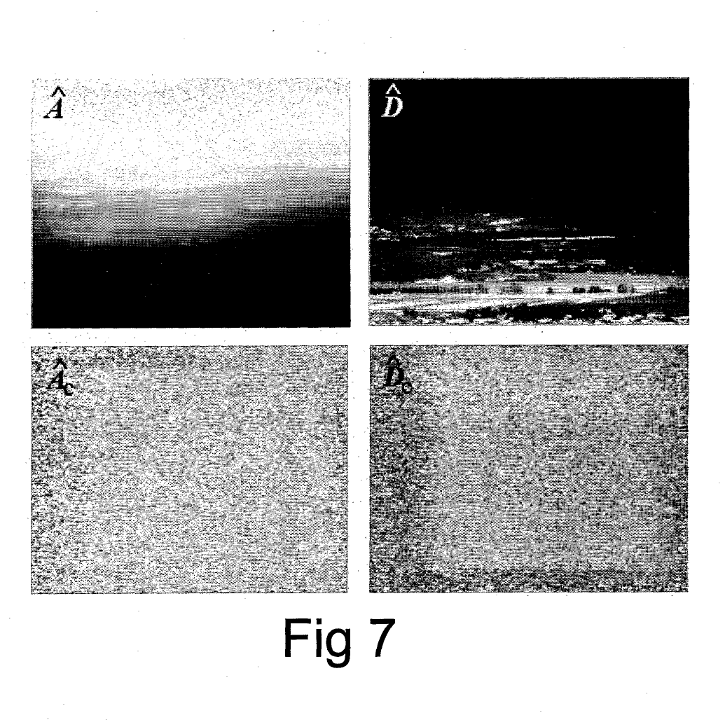

The strong negative correlation between A and D, corresponding to this scene is seen in FIG. 7. There are local exceptions to this observation, in places where the inherent object radiance L^{object} increases with z.

Nevertheless, due to this global correlation, A and D are highly mutually dependent.

FIG. 7 demonstrates the relationship between the direct transmission \hat{D} which generally decreases with distance and the airlight Â which increases with distance: The direct transmission D has a strong negative correlation to the airlight A. These images in FIG. 7 correspond to Scene 2. In a wavelet channel of these images Â_{c}, \hat{D}_{c} there is much less mutually dependency.

Fortunately, this statistical dependence does not occur in all image components, therefore ICA may be used. In fact, the high correlation mentioned above occurs in very low spatial frequency components: D decays with the distance only roughly. As noted, local behavior does not necessarily comply with this rough trend. Thus, in some image components (not low frequencies), we can expect significant independence as FIG. 7 demonstrates.

Hence, ICA can work in our case, if we transform the images to a representation that is more appropriate than raw pixels. We work only with linear transformations as in [17], since we wish to maintain the linear relations expressed in Eqs. (47)-(50). There are several common possibilities for linear operations that result in elimination of low frequencies.

One such option is wavelet transformation (see for example [38]), but the derivation is not limited to that domain. Other methods of removing low frequencies, such as Fourier domain high-pass filtering may be used. Define

D_{c}(x,y)=W{D(x,y)} (51)

as the wavelet (or sub-band) image representation of D. Here c denotes the sub-band channel, while W denotes the linear transforming operator. Similarly, define the transformed version of A, Â, \hat{D}, I^{max} and I^{min} as A_{c}, Â_{c}, \hat{D}_{c}, I_{c}^{max} and I_{c}^{min} respectively (see example in FIG. 7). Due to the commutativity of linear operations,

$$[ \begin{matrix}{\hat{A}}_{c} \\ {\hat{D}}_{c}\end{matrix} ] = W [ \begin{matrix}{I}_{c}^{max} \\ {I}_{c}^{min}\end{matrix} ] , \qquad ( 52 )$$

where W is the same as defined in Eq. (50).

We now perform ICA over Eq. (52). As we shall see in the experiments, this approach decreases in a very effective way the statistical dependency. Hence, the assumption of statistical independence in sub-band images is powerful enough to blindly deliver the solution. In our case, the solution of interest is the matrix W, from which we derive p.

Based on p, the airlight is estimated, and can then be separated from D(x,y), as described in Sec. 2.

4.2 Scale Insensitivity

When attempting ICA, we should consider its fundamental ambiguities [15]. One of them is scale: if two signals are independent, then they remain independent even if we change the scale of any of them (or both). Thus, ICA does not reveal the true scale of the independent components. This phenomenon can be considered both as a problem, and as a helpful feature. The problem is that the estimated signals may be ambiguous. However, in our case, we have a physical model behind the mixture formulation. As we shall see, this model eventually disambiguates the derived estimation. Moreover, we benefit from this scale-insensitivity. As will be shown in Sec. 4.3, the fact that ICA is insensitive to scale simplifies the intermediate mathematical steps we take.

An additional ICA ambiguity is permutation, which refers to mutual ordering of sources. This ambiguity does not concern us at all. The reason is that our physics-based formulation dictates a special form for the matrix W, and thus its rows are not mutually interchangeable.

4.3 Optimization Criterion

Minimization of statistical dependency is achieved by minimizing the mutual information (MI) of the sources. The MI of Â_{c} and \hat{D}_{c}, can be expressed as (see for example [6])

[symbol]

(Â_{c},\hat{D}_{c})= [symbol] + [symbol] − [symbol] (53)

Here [symbol] and [symbol] are the marginal entropies of Â_{c} and \hat{D}_{c}, respectively, while H_{Â}_{_{c}}_{,\hat{D}}_{_{c}}s their joint entropy. However, estimating the joint entropy from samples is an unreliable calculation. Therefore, it is desirable to avoid joint entropy estimation. In the following, we bypass direct estimation of the joint entropy, and in addition we describe other steps that enhance the efficiency of the optimization.

Let us look at the separation matrix W (Eq. 50). Its structure implies that up to a scale p, the estimated airlight Â is a simple difference of the two acquired images. Denote Ã_{c} as an estimation for the airlight component Â_{c}, up to this scale

Ã_{c}=I_{c}^{max}−I_{c}^{min}. (54)

Similarly, denote

\tilde{D}_{c}=w₁I_{c}^{max}+w₂I_{c}^{min}. (55)

as the estimation of up to a scale p, where

w₁≡(p−1), w₂≡(p+1). (56)

Hence, the separation matrix of Â_{c} and \hat{D}_{c} is

$$\tilde{W} = [ \begin{matrix}1 & - 1 \\ {w}_{1} & {w}_{2}\end{matrix} ] . \qquad ( 57 )$$

Minimizing the statistical dependency of Â_{c} and \hat{D}_{c} means that Ã_{c} and \tilde{D}_{c} should minimize their dependency too. We thus minimize the MI of Ã_{c} and \tilde{D}_{c},

[symbol]

(\tilde{D}_{c},Ã_{c})= [symbol] + [symbol] − [symbol] (58)

as a function of w₁ and w₂. This way we reduce the number of degrees of freedom of W to two variables, instead of four. This is thanks to the scale insensitivity and the physical model. Minimizing Eq. (58) yields estimates ŵ₁ and ŵ₂ which are related to w₁ and w₂ by an unknown global scale factor. This aspect is treated in Sec. 4.6.

As mentioned, estimating the joint entropy is unreliable and complex. Yet, Eqs. (47,49) express pointwise processes of mixture and separation: the airlight in a point is mixed only with the direct transmission of the same point in the raw frames. For pointwise [15] mixtures, Eq. (58) is equivalent to

[symbol]

(\tilde{D}_{c},Ã_{c})= [symbol] + [symbol] −log|det(\tilde{W})|− [symbol] (59)

Here, [symbol] is the joint entropy of raw frames. Its value is a constant set by the raw data, and hence does not depend on \tilde{W}. For this reason, we ignore it in the optimization process. Moreover, note from Eq. (54), that A_{c} does not depend on w₁, w₂. Therefore, [symbol] is constant and can also be ignored in the optimization process. Thus, the optimization problem we solve is simplified to

$$\{ {\hat{w}}_{1} , {\hat{w}}_{2} \} = arg {min}_{{w}_{1} , {w}_{2}} \{ {ℋ}_{{\tilde{D}}_{c}} - log \vert {w}_{2} + {w}_{1} \vert \} , \qquad ( 60 )$$

the matrix given in Eq. (57).

At this point, the following argument can come up. The separation matrix \tilde{W} (Eq. 57) has essentially only one degree of freedom p, since p dictates w₁ and w₂. Would it be simpler to optimize directly over p? The answer is no. Such a move implies that p=(ŵ₁+ŵ₂)/2.

This means that the scale of ŵ₁ and ŵ₂ is fixed to the true unknown value, and so is the scale of the estimated sources Â and \hat{D}). Hence scale becomes important, depriving us of the ability to divide \tilde{W} by p. Thus, if we wish to optimize the MI over p, we need to explicitly minimize Eq. (53). This is more complex than Eq. (60).

Moreover, this requires estimation of [symbol] which is unreliable, since the airlight A has very low energy in high-frequency channels c. The conclusion is that minimizing Eq. (60) while enjoying the scale insensitivity is preferable to minimizing Eq. (53) over p.

4.4 Efficiency by a Probability Model

In this section, further simplifications are performed, allowing for more efficient optimization. Recall that to enable linear ICA, we use high spatial frequency bands. In natural scenes, sub-band images are known to be sparse. In other words, almost all the pixels in a sub-band image have values that are very close to zero. Hence, the probability density function (PDF) of a sub-band pixel value is sharply peaked at the origin. A PDF model which is widely used for such images is the generalized Laplacian (see for example [38])

PDF(\tilde{D}_{c})=c(ρ,σ)exp[−(|\tilde{D}_{c}|/σ)^{ρ}], (61)

where ρε(0, 2) and σ are parameters of the distribution. Here c(ρ,σ) is a normalization constant. The scale parameter σ is associated with the standard deviation (STD) of the distribution. However, we do not need this scale parameter. The reason is that ICA recovers each signal up to an arbitrary intensity scale, as mentioned. Thus, optimizing a scale parameter during ICA is meaningless. We thus set a fixed unit scale (σ=1) to the PDF in Eq. (61). This means that whatever \tilde{D}_{c}(x,y) is, its values are implicitly re-scaled by the optimization process to fit this unit-scale model. Therefore, the generalized Laplacian in our case is

PDF(\tilde{D}_{c})=c(ρ)exp(−|\tilde{D}_{c}|^{ρ}). (62)

This prior of image statistics can be exploited for the entropy estimation needed in the optimization [4, 47]. Entropy is defined (see for example [6]) as

[symbol]

=ε{−log [PDF(\tilde{D}_{c})]}, (63)

where ε denoted expectation. Substituting Eq. (62) into Eq. (63) and replacing the expectation with empirical averaging, the entropy estimate is

$${\hat{ℋ}}_{{\tilde{D}}_{c}} = C ( ρ ) + \frac{1}{N} {\sum }_{x , y} {\vert {\tilde{D}}_{c} ( x , y ) \vert}^{ρ} . \qquad ( 64 )$$

Here N is the number of pixels in the image, while C(ρ)=log [c(ρ)]. Note that C(ρ) does not depend on \tilde{D}_{c}, and thus is independent of w₁ and w₂. Hence, C(ρ) can be ignored in the optimization process. The generalized Laplacian model simplifies the optimization problem to

$$\{ {\hat{w}}_{1} , {\hat{w}}_{2} \} = arg {min}_{{w}_{1} , {w}_{2}} \{ - log \vert {w}_{2} + {w}_{1} \vert + \frac{1}{N} {\sum }_{x , y} {\vert {\tilde{D}}_{c} ( x , y ) \vert}^{ρ} \} . \qquad ( 65 )$$

The cost function is a simple expression of the variables.

4.5 A Convex Formulation

Eq. (65) is simple enough to ease optimization. However, we prefer a convex formulation of the cost function, as it guarantees a unique solution, which can be reached efficiently using for example gradient-based methods or other methods known in the art.

First, note that \tilde{D}_{c}(x,y) is a convex function of w₁ and w₂, as seen in the linear relation given in Eq. (55). Moreover, the term [−log|w₁+w₂|] in Eq. (65) is a convex function of w₁ and w₂, in the domain (w₁+w₂)εR⁺. We may limit the search to this domain. The reason is that following Eq. (56), (ŵ₁+ŵ₂)=2kp where k is an arbitrary scale arising from the ICA scale insensitivity. If k>0, then (w₁+w₂)εR⁺ since by definition ρ≧0.

If k<0, we may simply multiply k by −1, thanks to this same insensitivity. Hence, the overall cost function (65) is convex, if |\tilde{D}_{c}|^{ρ} is a convex function of \tilde{D}_{c}.

The desired situation of having |\tilde{D}_{c}|^{ρ} convex occurs only if ρ≧1 Apparently, we should estimate ρ at each iteration of the optimization, by fitting the PDF model (Eq. 61) to the values of \tilde{D}_{c}(x,y). Note that this requires estimation of σ as well. The parameters ρ and ρ can be estimated by minimizing the relative entropy [38] (the Kullback-Leibler divergence) between the histogram of \tilde{D}_{c}(x,y) to the PDF model distribution. However, this is computationally complex.

Therefore, we preferred using an approximation and set the value of ρ, such that convexity is obtained. Note that ρ<1 for sparse signals, such as typical sub-band images.

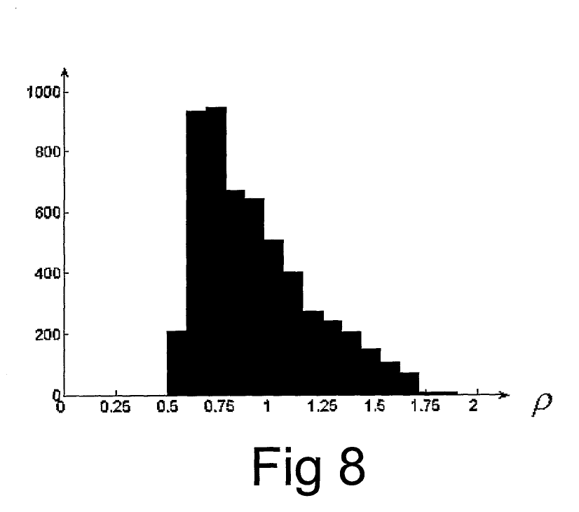

The PDF representing the sparsest signal that yields a convex function in Eq. (65) corresponds to ρ=1. Thus we decided to use ρ=1 (see also [4, 22, 47]). By this decision, we may have sacrificed some accuracy, but enabled convexity. In contrast to the steps described in the previous sections, the use of ρ=1 is an approximation. How good is this approximation? To study this, we sampled 5364 different images \tilde{D}_{c}(x,y). These images were based on various values of p, c and on different raw frames. Then, the PDF model (Eq. 61) was fitted to the values of each image. The PDF fit yielded an estimate of ρ per image. A histogram of the estimates of ρ over this ensemble is plotted in FIG. 8. Here, ρ=0.9±0.3. It thus appears that the approximation is reasonable.

The approximation turns the minimization of I(Â, \hat{D}) to the following problem

$$\{ {\hat{w}}_{1} , {\hat{w}}_{2} \} = {min}_{{w}_{1} , {w}_{2}} \{ - log \vert {w}_{2} + {w}_{1} \vert + \frac{1}{N} {\sum }_{x , y} \vert {\tilde{D}}_{c} ( x , y ) \vert \} , \\ Where {\tilde{D}}_{c} = {w}_{1} {I}_{c}^{max} + {w}_{2} {I}_{c}^{min} . \qquad ( 66 )$$

Eq. (66) may be used for our optimization. It is unimodal and efficient to solve. For convex functions such as this, convergence speed is enhanced by use of local gradients.

FIG. 8 shows a histogram of ρ, based on PDFs fitted to data of 5364 different images \tilde{D}_{c}, which were derived from various values of p, wavelet channels c and different raw images. In this histogram, ρ=0.9±0.3.

4.6 Back to Dehazing

The optimization described in Sections. 4.3, 4.4 and 4.5 yields estimated ŵ₁ and ŵ₂. We now use these values to derive an estimate for p. Apparently, from Eq. (56), \hat{p} is simply the average of ŵ₁ and ŵ₂. However, ICA yields ŵ₁ and ŵ₂ up to a global scale factor, which is unknown. Fortunately, the following estimator

$$\hat{p} = \frac{{\hat{w}}_{1} + {\hat{w}}_{2}}{{\hat{w}}_{2} + {\hat{w}}_{1}} \qquad ( 67 )$$

is invariant to that scale. This process is repeated in each color channel.

Once \hat{p} is derived, it is used for constructing W in Eq. (50). Then, Eq. (49) separates the airlight Â and the direct transmission \hat{D}. This recovery is not performed on the sub-band images. Rather, it is performed on the raw image representation, as in prior sky-based dehazing methods.

We stress that in this scheme, we bypass all inherent ICA ambiguities: permutation, sign and scale. Those ambiguities do not affect us, because we essentially recover the scene using a physics-based method, not a pure signal processing ICA. We use ICA only to find \hat{p}, and this is done in a way (Eq. 67) that is scale invariant.

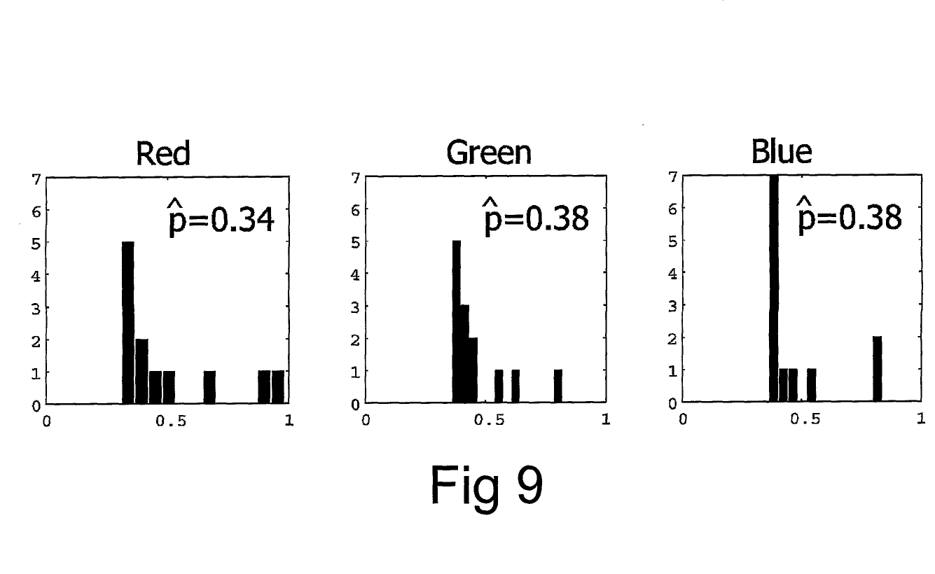

FIG. 9 shows histograms of \hat{p} across the wavelet channels, corresponding to FIG. 1. In each color channel, we choose the most frequent value of \hat{p}.

A Note about Channel Voting

In principle, the airlight DOP p should be independent of the wavelet channel c. However, in practice, the optimization described above yields, for each wavelet channel, a different estimated value \hat{p}. The reason is that some channels better comply with the independence assumption of Sec. 4.1, than other channels. Nevertheless, there is a way to overcome poor channels. Channels that do not obey the assumptions yield a random value for \hat{p}. On the other hand, channels that are “good” yield a consistent estimate. In the preferred embodiment, the optimal \hat{p} is determined by voting. Moreover, this voting is constrained to the range \hat{p}ε[0, 1], due to Eq. (66). It should be noted that other methods of identifying the most probable p are known in the art, For example statistical analysis may fit a distribution of values of p, from which the most probable one is selected. Any value outside this range is ignored. As an example, the process described in this section was performed on Scene 1. The process yielded a set of \hat{p} values, one for each channel. FIG. 9 plots the voting result as a histogram per color channel. The dominant bar in each histogram determines the selected values of \hat{p}.

5. Inhomogeneous Distance

To separate A from D using ICA, both must be spatially varying. Consider the case of a spatially constant A. This occurs when all the objects in the FOV are at the same distance z from the camera. In this case, [symbol] and I(A_{c}, D_{c}) are null, no matter what the value of the constant A is. Hence, ICA cannot derive it. Therefore, to use ICA for dehazing, the distance z must vary across the FOV. Distance non-uniformity is also necessary in the other methods (not ICA-based), described in Sec. 3, for estimating p and A_{∞}. We note that scenarios having laterally inhomogeneous z are the most common and interesting ones. Ref. [25] noted that the main challenge of vision in bad weather is that generally object distances vary across the FOV, hence making the degradation effects spatially variant. In the special cases where z is uniform, dehazing by Eq. (13) is similar to rather standard contrast stretch: subtracting a constant from I^{total}, followed by global scaling. Hence the methods described in this paper address the more common and challenging cases. Thus, the importance to sometimes provide different images for extracting haze parameters.

### C. Method of Image Processing

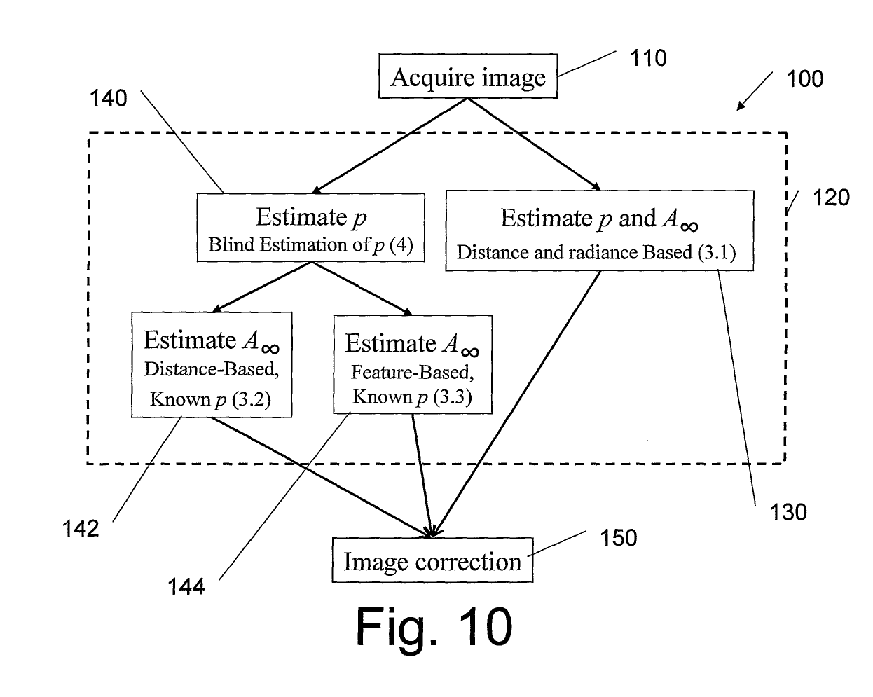

Attention is now drawn to FIG. 10 schematically depicting the method 100 of image processing according to exemplary embodiments of the current invention.

Raw image data is acquired 110 using camera 210 as described in FIG. 2.

Haze parameters p and A_{∞} are determined for regions of interest in the image in image analysis 120.

Effect of the haze is corrected in image correction stage 150, where global parameters p and A_{∞} from image analysis 120 are used to correct the image. The corrected image \hat{L}^{object}(x, y) is than displayed on display 222.

Data Acquisition

Raw image data is acquired 110 using camera 210 as described in FIG. 2, according to an exemplary embodiment of the invention. At least two images are acquired at two substantially perpendicular polarization states of polarizer 212. Preferably, the polarization states are chosen at such that haze contribution is at the extrema. The images are selected so they at least partially overlap (data processing can effectively perform on the overlapping area) and preferably include objects at substantially different distances. However, in contrast to methods of the art, these imaged need not include area of sky.

Optionally, distances to at least two objects or locations in the image are supplied by auxiliary unit 260.

Image Analysis

Image analysis 120 may be performed in several ways, all within the general scope of the current invention. Selection of the appropriate method depends on the available data and the image acquired.

Optionally, plurality of these methods may be performed and the resulted corrected images are shown to the user. Alternatively or additionally, parameters obtained by the plurality of methods may be combined, for example as weighted average, and used for the correction stage 150.

Distance and Radiance Based Estimation of Both p and A_{∞}

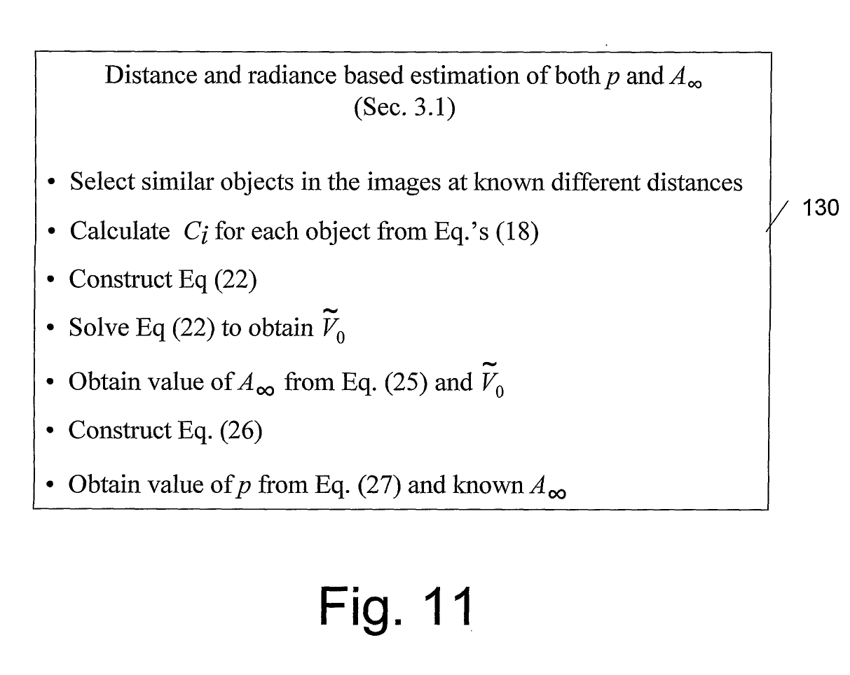

According to one exemplary embodiment of the current invention, a distance based estimation method 130 for obtaining both global haze parameters p and A_{∞} is depicted in FIG. 11, allowing image analysis based on identification of at least two similar objects situated at known distances within the acquired image. The theoretical justification for this exemplary embodiment is detailed in section 3.1.

In order to perform this data analysis, at least two similar objects are selected in the overlapping area of the acquired images. The two objects are selected such that their distances from camera 220 are known, for example from auxiliary unit 260. The selected object are objects known to have similar the object radiance L^{object}. These objects may be buildings known to be of same color, area of vegetation of the same type, etc.

For each selected object “i” situated at distance zᵢ from the camera, Cᵢ is evaluated from Eq. (18) by subtracting the signals corresponding to the two acquired images.

In general, each object may span plurality of image pixels. Cᵢ may represents the average values of the object's pixels, thus the selected objects are optionally of different sizes. When more than two similar objects are selected, or plurality of object pairs are selected, effective global parameters may be obtained by averaging the calculated global parameters or by best fitting global parameters to the over constrained equations.

Eq. (22), having the unknown V, is constructed from the computed values Cᵢ and the known distances zᵢ.

Eq. (22) is generally numerically solved to obtain the solution V₀ using methods known in the art.

Based on solution for V₀, Eq. (25) is evaluated to yield the desired value of the global haze parameter A_{∞}.

Eq. (26) is than evaluated using the value for V₀ and inserted into Eq. (27) to yield the global haze parameter p.

Blind Estimation of p

According to another exemplary embodiment of the invention, global haze parameter p is first determined, and is subsequently used to calculate the global haze parameter A_{∞}.

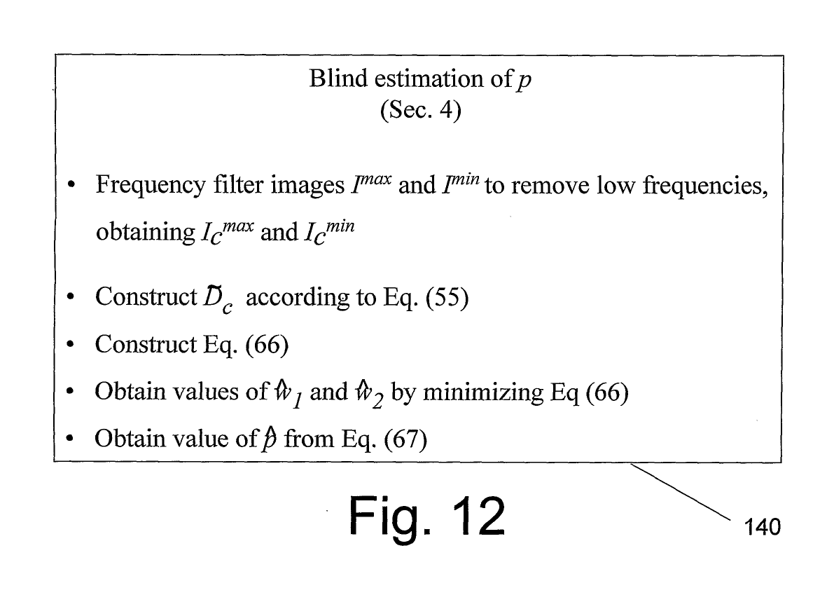

According to one embodiment of the current invention, a blind estimation method 140 for obtaining the global haze parameter p is depicted in FIG. 12, allowing image analysis based only the acquired image, provided that the overlapping area in the images includes dissimilar object at plurality of distances from the camera. Generally, this is the case for imaged scenery. The theoretical justification for this exemplary embodiment is detailed in section 4.

To perform the analysis, the two acquired images are filtered to remove the low frequency components, preferably using wavelets analysis. The filtered images are now presented as luminosity per channel, for example pixel (x, y), as I_{c}^{max} and I_{c}^{min}.

A linear combination \tilde{D}_{c} of I_{c}^{max} and I_{c}^{min} is defined using Eq. (55) using two unknown w₁ and w₂.

Values for the unknown w₁ and w₂ is obtained by minimizing Eq (66).

The obtained values w₁ and w₂ are used to obtain value of global haze parameter p from Eq. (67).

Global haze parameter p from blind estimation method 140 may be used for obtaining haze parameters A_{∞} using any of estimation methods 142 and 144 depicted below.

Distance-Based, Known p Estimation A_{∞}

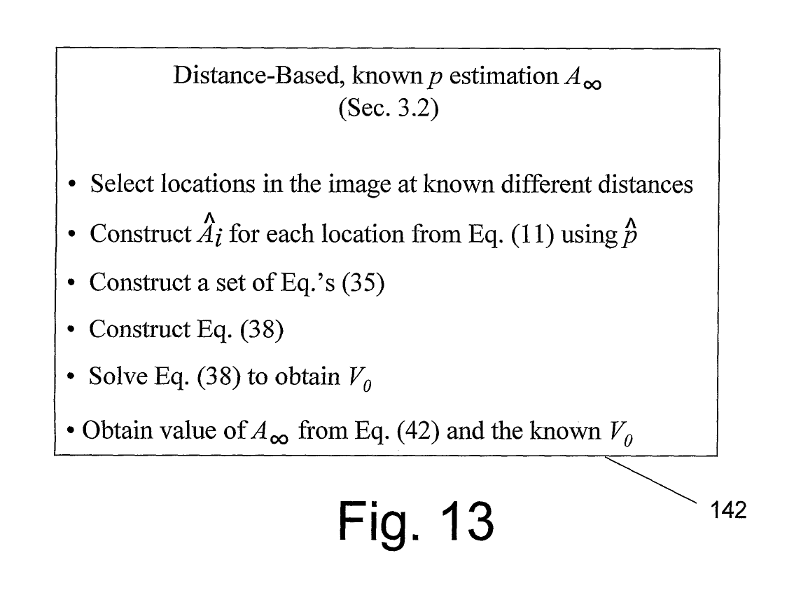

According to an exemplary embodiment of the current invention, a distance based, known p estimation method 142 for obtaining the haze parameter A_{∞} is depicted in FIG. 13, allowing image analysis based on identification of at least two areas situated at known and different distances zᵢ within the acquired image. Distances zᵢ from the camera to each area may be supplied by auxiliary unit 260. Relative distances (known in some arbitrary units) suffice. In contrast to the distance based estimation method 130, the objects in the selected areas need not have same luminosities.

The theoretical justification for this exemplary embodiment is detailed in section 3.2.

Using the known global haze parameter p, for each area “i”, an Âᵢ is constructed from the acquired images according to Eq. (11).

In general, each area may span plurality of image pixels. Âᵢ may represents the average values of the area's pixels, thus the selected area are optionally of different sizes. When more than two areas are selected, effective global parameters may be obtained by averaging the calculated global parameters or by best fitting global parameters to the over constrained equations.

A set of equations are thus constructed using the known distances zᵢ having two unknowns V and A_{∞} using Eq. (35) (wherein “(x,y)” stands as “i” for identifying the area).

To solve the abovementioned set of equation, Eq. (38) is constructed, having only one unknown V.

Eq. (38) is generally numerically solved to obtain the solution V₀ using methods known in the art.

Based on solution for V₀, Eq. (42) is evaluated to yield the desired value of the global haze parameter A_{∞}.

Feature-Based, Known p Estimate A_{∞}

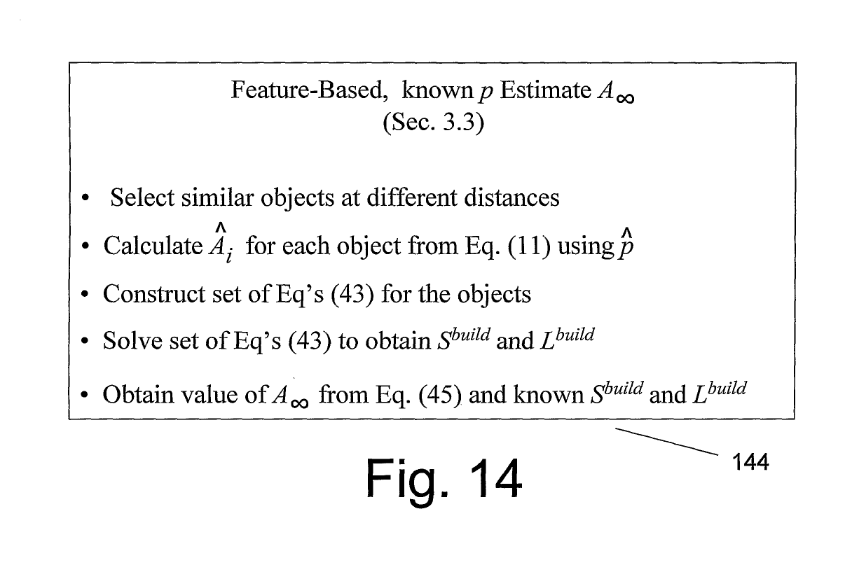

According to an embodiment of the current invention, a feature based, known p estimation method 144 for obtaining the haze parameters A_{∞} is depicted in FIG. 14, allowing image analysis based on identification of at least two similar objects situated at different distances within the acquired image. The selected object are objects known to have similar the object radiance L^{object}. These objects may be buildings known to be of same color, area of vegetation of the same type, etc. In contrast to the distance-based estimation method 142, the distances to the selected areas need to be substantially different, but need not be known. The theoretical justification for this exemplary embodiment is detailed in section 3.3.

Using the known global haze parameter p, for each object “i”, an Âᵢ is constructed from the acquired images according to Eq. (11).

In general, each object may span plurality of image pixels. Âᵢ may represent the average values of the area's pixels, thus the selected area are optionally of different sizes. When more than two objects are selected, or plurality of object pairs are selected, effective global parameters may be obtained by averaging the calculated global parameters or by best fitting global parameters to the over constrained equations.

From Eq. (43) it is apparent that the total acquired signal from object “k”; Îₖ^{total}, defined by Eq. (10) is a linear transformation of Âᵢ having L^{build} as its intercept and S^{build} as its slope (wherein “(x,y)” stands as “i” for identifying the object).

Thus, using two or more selected objects, it is easy to solve for L^{build} and S^{build} using graphical methods; numerical methods; or fitting methods known in the art.

Inserting the obtained L^{build} and S^{build} into Eq. (45), the value of global haze parameter A_{∞} may be obtained.

Image Correction

Haze parameters p and A_{∞} are determined for regions of interest in the image in image analysis 120.

Effect of the haze is corrected in image correction stage 150, where global parameters p and A_{∞} from image analysis 120 are used to correct the image. The corrected image \hat{L}^{object}(x,y) is than displayed on display 222.

It should be noted that global parameters p and A_{∞} may be separately computed for sections of the images and applied in the correction accordingly. Separate analysis may be advantageous when the image spans large angle such that haze conditions changes within the image. It also should be noted that since global parameters are slowly varying in time, mainly though weather changes and changes in sun positioning, image analysis 120 may be performed at infrequent intervals and applied to plurality of images taken at similar conditions. Similarly, distances to objects in the image are generally unchanged and may be obtained once.

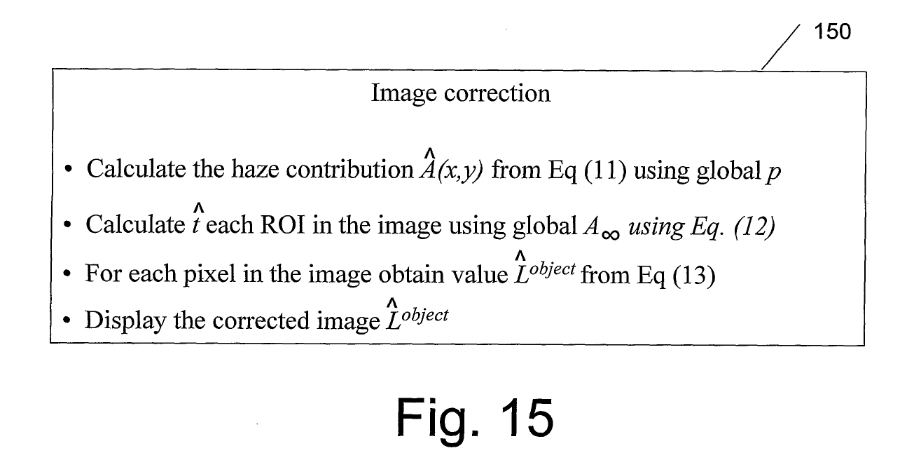

FIG. 15 schematically depicts the stage of image correction according to an exemplary embodiment of the invention.

For each pixel (x,y) in the image, the haze contribution A(x,y)I is calculated from Eq (11) using global haze parameter. Since haze is spatially slowly varying, the haze contribution may be smoothed. Smoothing may take into account knowledge about the scenery such as the existence of sharp edge in the haze contribution such as at the edge of a mountain range and be tailored to create domains of continuously, optionally Monotonically varying haze contribution.

Optionally haze contribution may be subtracted from the acquired image to obtain the direct transmission:

D=I^{total}−A (68)

and the results displayed to the used.

Preferably, attenuation t for each pixel in the image is calculated using the haze contribution A, the global haze parameter A_{∞} using Eq. (12).

For each pixel in the image, the estimation of the object luminosity is than obtain from Eq (13) and displayed to the user.

From Eq. (2), it apparent that distances to each object in the image could be obtained from t by:

z(x,y)=−log [t(x,y)]/β, (69)

where the attenuation coefficient β may be obtain by solving Eq. (69) for at least one location in the image to which the distance is known.

A “distance map” z(x,y) may be created and displayed to the user in association with the processed or original image. Foe example, distance to an object may be provided by pointing to a location on the image. Alternatively or additionally, distance information, for example in the form of contour lines may be superimposed on the displayed image.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method of correcting scatter effects in an acquired image comprising the steps of:
acquiring first image at first polarization state;
acquiring second image at second polarization state, wherein said first and said second image overlap;
estimating haze parameters from said first and second images; and
correcting acquired image using said estimated haze parameters, wherein said estimating haze parameters from said first and second images does no rely on identifying one of: sky and two type of similar object pairs in the acquired image.

2. The method of claim 1 wherein the second polarization state is essentially perpendicular to the first polarization state.

3. The method of claim 2 wherein the first polarization state is chosen to essentially minimize the effect of atmospheric haze.

4. The method of claim 1 wherein the step of estimating haze parameter comprises the steps of:
selecting within first and second images at least two image areas corresponding to scene areas at situated at substantially different distances with known relative distances, and having known ratio of radiance characteristics; and
solving for haze parameters based on the data extracted from these two areas.

5. The method of claim 1 wherein the step of estimating haze parameters comprises blind estimation of the haze parameter p from analyzing high spatial frequency content of first and second images.

6. The method of claim 5 wherein analyzing high spatial frequency content of first and second images comprises wavelet analysis of said first and second images.

7. The method of claim 5 wherein the step of estimating haze parameters comprises using the estimated parameter p to estimate the haze parameter A_{∞}.

8. The method of claim 7 wherein the step of using the estimated parameter p to estimate the haze parameter A_{∞}comprises identifying at least two image areas corresponding to scene areas situated at substantially different distances from the image-acquiring camera wherein ratio of said distances is known; and solving for the haze parameters based on the data extracted from these two areas.

9. The method of claim 6 wherein the step of using the estimated parameter p to estimate the haze parameter A_{∞} comprises identifying at least two image areas corresponding to scene areas at substantially different distances, having known ratio of radiance characteristics; and solving for the haze parameters based on the data extracted from these two areas.

10. A method for determining the degree of polarization p of light scattered by a scattering medium comprising the steps of:
obtaining an image dataset wherein each location is said dataset is characterized by at least two intensity values corresponding to different polarization states;
seeking a value for the parameter p that minimizes the crosstalk between the signal estimated to be reflected from the object in said image to the signal estimated to be scattered from the scattering medium.

11. The method of claim 9 wherein the step of seeking a value for the parameter p comprises separating high spatial frequency content of the image dataset.

12. The method of claim 10 wherein the step of separating high spatial frequency content of the image dataset comprises wavelet analysis of said image dataset.

13. The method of claim 1 wherein the steps of acquiring first image at first polarization state and acquiring second image at second polarization state, wherein said first and said second image overlap is done using at least one imaging parameter different than the acquisition of image to be corrected.

14. The method of claim 12 wherein the different imaging parameter used for acquisition of image to be corrected is the polarization state.

15. The method of claim 12 wherein the different imaging parameter used for acquisition of image to be corrected is the image magnification.

16. The method of claim 12 wherein the different imaging parameter used for acquisition of image to be corrected is the use of a separate camera.

17. The method of claim 12 wherein the different imaging parameter used for acquisition of image to be corrected is the direction of the imaging camera.

18. The method of claim 1 wherein the step of estimating haze parameter comprises the steps of:
selecting within first and second images at least two image areas corresponding to scene areas at situated at substantially the same distances with known and different ratio of radiance characteristics; and
solving for haze parameters based on the data extracted from these two areas.

19. The method of claim 18, wherein the step of selecting within first and second images at least two image areas corresponding to scene areas at situated at substantially the same distances with known and different ratio of radiance characteristics comprises selecting within first and second images at least three image areas corresponding to scene areas at situated at substantially the same distances with known and different ratio of radiance characteristics.

20. The method of claim 18 wherein the wherein absolute radiance characteristics of at least on of the selected area is known.

21. The method of claim 1 wherein the step of correcting acquired image comprises low pass filtering of estimated haze effects.

22. The method of claim 1 and further displaying information indicative of distances to areas in the image.

23. A system for of correcting scatter effects in an acquired image comprising:
a first and second camera, wherein said first camera comprises a polarizer; and
a computer receiving image data from said first and second camera, and uses parameters extracted from data acquired by first camera to correct an image acquired by said second camera.
